(19) United States
(12) Patent Application Publication
(10) Pub. No.: US 2025/0247441 A1
(43) Pub. Date: Jul. 31, 2025

(54) SECURE WEB HOSTING THROUGH VIRTUAL HOSTED BROWSERS

(71) Applicant: MIRRORTAB CORP., San Francisco, CA (US)

(72) Inventors: Brian Silverstein, San Carlos, CA (US); Christopher Jelly, San Francisco, CA (US); Brandon Block, San Francisco, CA (US); Jack Tannenbaum, San Francisco, CA (US)

(73) Assignee: MIRRORTAB CORP., San Francisco, CA (US)

(21) Appl. No.: 19/070,896

(22) Filed: Mar. 5, 2025

Related U.S. Application Data
(60) Provisional application No. 63/625,172, filed on Jan. 25, 2024.

(51) Int. Cl. H04L 67/02; G06F 9/455; G06F 16/957

(52) U.S. Cl. CPC H04L 67/02; G06F 9/45558; G06F 16/9577; G06F 2009/45595

(57) ABSTRACT

Disclosed embodiments provide a framework for provisioning a hosted website instance within a private site hosting subnetwork for hosting a website through a virtual hosted browser application. The hosted website instance is accessible to a virtual machine instance, which can retrieve the web assets associated with the hosted website from the hosted website instance in response to requests to access the hosted website. The virtual machine instance encodes the web assets associated with the hosted website to generate a data representation of the website. The data representation of the website corresponds to a graphical facsimile of the website. The data representation of the website is transmitted to the requesting users to fulfill the requests. When the data representation of the website is received by these users, the data representation of the website is decoded to present a graphical facsimile of the website.

### CROSS-REFERENCE TO RELATED APPLICATIONS

The present patent application claims the priority benefit of U.S. provisional patent application No. 63/625,172 filed Jan. 25, 2024, the disclosures of which are incorporated by reference herein.

### FIELD

The present disclosure relates generally to systems and methods for hosting websites and corresponding assets through virtual hosted browser applications. The virtual hosted browser applications allow for user access to websites through isolated virtual environments.

### SUMMARY

Disclosed embodiments provide a framework for provisioning a hosted website instance within a private site hosting subnetwork for hosting a website through a virtual hosted browser application. The hosted website instance is accessible to a virtual machine instance, which can retrieve the web assets associated with the hosted website from the hosted website instance in response to requests to access the hosted website. The virtual machine instance encodes the web assets associated with the hosted website to generate a data representation of the website. The data representation of the website corresponds to a graphical facsimile of the website. The data representation of the website is transmitted to the requesting users to fulfill the requests. When the data representation of the website is received by these users, the data representation of the website is decoded to present a graphical facsimile of the website.

According to some embodiments, a computer-implemented method is provided. The computer-implemented method comprises receiving a hosting request to host a website on a virtual site hosting subnetwork. The hosting request includes a web Document Object Model (DOM) and one or more assets associated with the web DOM. Further, the website is implemented using the web DOM. The computer-implemented method further comprises provisioning a hosted website instance for the website. The hosted website instance provides the web DOM and the one or more assets through the virtual site hosting subnetwork. The computer-implemented method further comprises receiving a website access request for accessing the website. The website access request is received through a website rendering instance implemented through a virtual site rendering subnetwork. The computer-implemented method further comprises encoding the web DOM and the one or more assets to generate data usable to generate a graphical facsimile of the website. The data is generated through the website rendering instance. Further, the website rendering instance obtains the web DOM and the one or more assets from the hosted website instance. The computer-implemented method further comprises transmitting data to fulfill the website access request. The data is transmitted through the website rendering instance. Further, when the data is received, the data is decoded to generate and present the graphical facsimile of the website.

In some embodiments, the hosting request is transmitted through a command line interface (CLI) call to an application programming interface (API) associated with the virtual site hosting subnetwork.

In some embodiments, the web DOM and the one or more assets are not accessible through the website rendering instance.

In some embodiments, the data is generated using a Web Real-Time Communication (WebRTC) protocol. Further, the data includes a set of pixels generated using the WebRTC protocol. The set of pixels is used to generate the graphical facsimile of the website.

In some embodiments, the computer-implemented method further comprises identifying a Uniform Resource Identifier (URI) associated with the website. The URI is identified based on the hosting request. The computer-implemented method further comprises updating one or more DNS servers to map the URI to the website rendering instance.

In some embodiments, the computer-implemented method further comprises transmitting a set of executable instructions that, as a result of being executed, cause an option to inspect the graphical facsimile of the website to become disabled.

In some embodiments, the web DOM and the one or more assets are encoded according to a custom data structure. Further, the custom data structure is indicated through the hosting request.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which a secure web hosting platform hosts a website through a virtual machine instance on behalf of a website owner in accordance with at least one embodiment;

FIGS. 2A-2C show an illustrative example of an environment in which a secure web hosting platform hosts and renders a website on behalf of a website owner within a site hosting subnetwork of the secure web hosting platform through which users can access a graphical facsimile of the website through virtual hosted browser applications implemented by the secure web hosting platform in accordance with at least one embodiment;

FIGS. 3A-3D show an illustrative example of an interface through which a website owner configures a website to be hosted through the secure web hosting platform in accordance with at least one embodiment;

FIG. 4 shows an illustrative example of an environment in which a website owner submits an application programming interface (API) call through a command line interface (CLI) to the secure web hosting platform to provide a set of web assets for a website to be hosted through the secure web hosting platform in accordance with at least one embodiment;

FIG. 5 shows an illustrative example of a process for hosting a website through a virtual machine instance in accordance with at least one embodiment;

FIG. 6 shows an illustrative example of a process for encoding a web DOM associated with a hosted website in order to prevent exposure of the web DOM while providing an opaque representation of the hosted website to a user accessing the hosted website in accordance with at least one embodiment; and

FIG. 7 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing a preferred examples of embodiment. It is understood that various changes can be made in the function and arrangement of elements without departing from the spirit and scope as set forth in the appended claims.

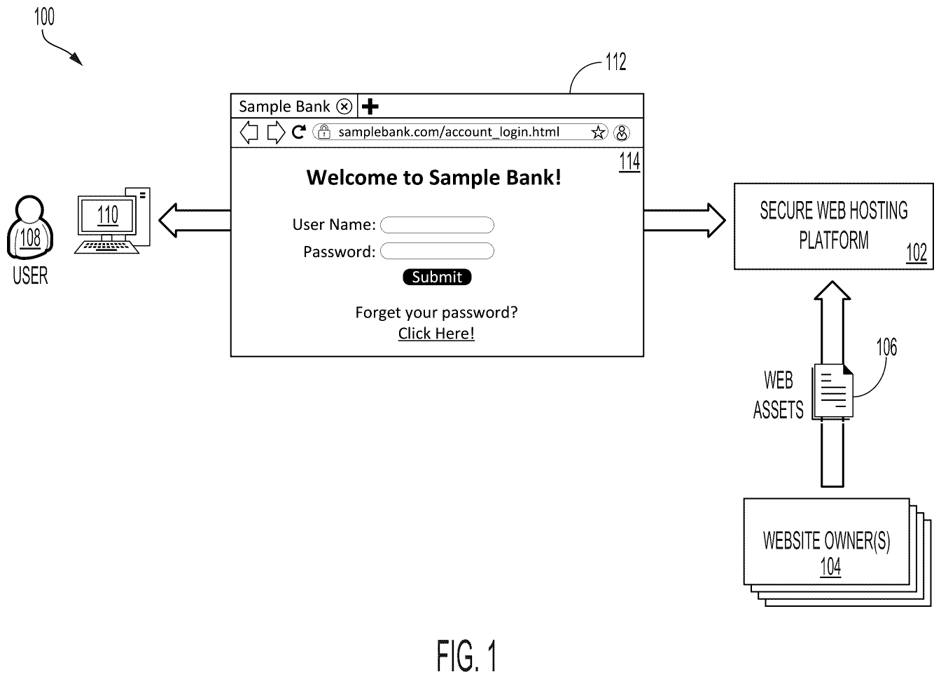

FIG. 1 shows an illustrative example of an environment 100 in which a secure web hosting platform 102 hosts a website 114 through a virtual machine instance on behalf of a website owner 104 in accordance with at least one embodiment. In the environment 100, a website owner 104 of a website (e.g., website 114) may access a secure web hosting platform 102 to configure a website that may be hosted by the secure web hosting platform 102 on behalf of the website owner 104. In addition to configuring the website that is to be hosted by the secure web hosting platform 102, the website owner 104 may further configure automatic translation of the website for presentation of a graphical facsimile of the website to users (such as user 108) when these users submit requests to access the website. The secure web hosting platform 102 may include various computing resources (e.g., physical hosts, servers, mainframes, etc.) that may be configured to instantiate virtual machine instances onto virtual computer systems on behalf of different entities, such as users and website administrators.

In an embodiment, the secure web hosting platform 102 providers website owners 104 with various configuration options for hosting and managing their websites through a site hosting subnetwork implemented by the secure web hosting platform 102. For instance, the secure web hosting platform 102 may provide a website owner 104 with an interface (such as a graphical user interface (GUI)) through which the website owner 104 may generate a workspace for deploying a website 114 to the secure web hosting platform. Through this interface, the website owner 104 may submit a request to provision a virtual machine instance within the site hosting subnetwork and through which a particular website 114 may be hosted.

The secure web hosting platform 102, in an embodiment, provides the website owner 104 with various configuration options for the virtual machine instance through which the website 114 is to be hosted. For instance, the secure web hosting platform 102 may provide various memory options for a virtual machine instance through which the website is to be hosted, where the amount of memory provided in each configuration option may correspond to the available functionality of the virtual machine instance. As an illustrative example, a configuration option that includes a greater amount of memory allocation may allow for a virtual machine instance that enables streaming of digital video and audio at higher fidelity compared to a configuration option with less memory allocation. As another illustrative example, a configuration option may include an amount of memory allocation corresponding to the particular codec being implemented for rendering and translation of the website into a graphical facsimile of the website that may be presented to users. Example codecs that may be implemented by the secure web hosting platform 102 for generating graphical facsimiles of different websites hosted by the secure web hosting platform 102 include, but are not limited to: video stream codecs (e.g., MP4, MOV, WebM, AVI, AV1, AVCHD, FLV, WMV, H.264, MPEG, etc.), server-side rendered Skia codecs, remotely-executed JavaScript with HyperText Markup Language (HTML) streaming, and any other codecs known in the art.

In some instances, rather than providing configuration options that specify computing specifications for a virtual machine instance, the secure web hosting platform 102 may provide configuration options that specify attributes that are specific to the virtual machine instance. For example, a particular configuration option may specify the capabilities of the virtual machine instance, such as the resolution available for digital video streaming and the like. In addition to providing memory options for the virtual machine instance, the secure web hosting platform 102 may further provide bandwidth, storage, and/or processor or vCPU options for its virtual machine instance. For instance, the secure web hosting platform 102 may provide one or more bandwidth (e.g., upload and/or download) options for the virtual machine instance.

In some instances, the secure web hosting platform 102 may allow a website owner 104 to define a set of configuration requirements for the virtual machine instance through which the website 114 is to be hosted. For instance, a website owner 104 may specify that the website 114 is to be supported by a virtual machine instance having a minimum amount of random-access memory (RAM), a minimum number of virtual central processing units (vCPUs), minimum storage capacity, a minimum amount of available bandwidth, and the like. Further, a website owner 104 may specify which browser application is to be implemented within the virtual machine instance for presentation of the website 114. For instance, a website owner 104 may specify that the virtual machine instance is to implement a Google Chrome™ browser application as opposed to Microsoft Edge®, Mozilla Firefox®, or any other available browser application. Alternatively, the website owner 104 may specify that it is agnostic as to which browser application is implemented within the virtual machine instance so long as the minimum configuration requirements for the website 114 are satisfied.

In an embodiment, the virtual machine instance utilized to implement and host the website 114 is instantiated such that the website 114 may only be accessed through a website rendering network of the secure web hosting platform 102. For instance, the virtual machine instance may include an operating system, a browser application, and a variety of other applications that may be executed to support the browser application, and any other functionality required for the implementation of the website 114. The secure web hosting platform 102 may restrict access to the virtual machine instance instantiated for the website 114 such that users may only be able to access the website 114 through a virtual machine instance implemented within the website rendering network of the secure web hosting platform 102. This may prevent users from accessing the virtual machine instance within the site hosting subnetwork.

In an embodiment, in addition to implementation and hosting of websites through a site hosting subnetwork, the secure web hosting platform 102 may implement a virtual machine instance within a site rendering subnetwork of the secure web hosting platform 102 to automatically, and in real-time, translate the web DOM associated with a website 114 into a data structure that obfuscates the web DOM associated with the particular website 114 but that may be decoded by computing devices (such as computing device 110 utilized by a user 108) to allow for presentation of a graphical facsimile of the website 114. This graphical facsimile of the website 114 may be presented to users without exposure of the web DOM associated with the particular website 114, as the graphical facsimile of the website 114 is generated using an alternative data structure that does not include the web DOM associated with the particular website 114. In an embodiment, this virtual machine instance includes one or more software containers that include one or more applications or programs that can automatically encode the web DOM associated with a particular website 114 and generate a graphical facsimile of the particular website 114 in real-time that may be provided to users attempting to access the particular website 114.

In an embodiment, a user 108 can use a browser application implemented on their computing device 110 to access the graphical facsimile of the website 114 through the virtual machine instance implemented in the site rendering subnetwork of the secure web hosting platform 102. The virtual machine instance may include a viewer page that includes a virtual browser application environment viewer. Through the virtual browser application environment viewer, the user 108 may access and view the virtual browser application environment using their browser application. In an embodiment, the virtual browser application environment is automatically rendered when the user 108 accesses the virtual machine instance using the URI of the website 114. For instance, in response to the request to access the website 114, the virtual machine instance may present the website through the virtual browser application environment viewer. However, the virtual browser application environment viewer may be presented in a manner that prevents the user 108 from discovering that the website 114 is being rendered and presented through the virtual browser application environment viewer. For example, the virtual browser application environment viewer may be presented as the website 114 itself as opposed to a frame within a viewer page. This may allow the user 108 to navigate the website 114 through the virtual browser application environment viewer without the user 108 being able to discern that the website 114 is actually being accessed through a virtual browser application implemented on the virtual machine instance.

In an embodiment, the secure web hosting platform 102 implements a WebSocket Secure (WSS) or other secure communications protocol through which user interactions with the graphical facsimile of the website 114 may be transmitted to the secure web hosting platform 102. For instance, the user 108, through their computing device 110, may transmit an API call using the WSS protocol or other secure communications protocol to establish a secure communications channel with the virtual machine instance in order to provide any sensitive information (or other data the user 108 does not want to have publicly exposed) to the secure web hosting platform 102. This sensitive information or other data may include passwords, search terms or queries, cut and paste buffers, cookies, and the like. Through the API call, the user 108 may define a set of parameters corresponding to the type(s) of data that are to be securely passed to the virtual machine instance and processed by the secure web hosting platform 102. The set of parameters may correspond to one or more portions of the graphical facsimile of the website 114 as transmitted to the user's computing device 110. For example, if the graphical facsimile of the website 114 includes data entry fields for entry of the user's username and password (as illustrated in FIG. 1), the user 108, through their computing device 110, may transmit an API call using the WSS protocol or other secure communications protocol to establish a secure communications channel with the virtual machine instance to allow for entry and transmission of the user's username and password through the graphical facsimile of the website 114.

In some instances, in order to provide the one or more interactive elements of the graphical facsimile of the website 114 and through which the user 108 may provide sensitive information or other information that the user 108 would not want publicly exposed, the user 108 may be required to transmit the API call using the WSS protocol or other secure communications protocol to establish the secure communications channel with the virtual machine instance. For instance, when the user 108 enters, through their browser application, the URI corresponding to the website 114 hosted by the secure web hosting platform 102, the user 108 may transmit the API call to the virtual machine instance used to render and transmit the graphical facsimile of the website 114. As noted above, through the API call, the user 108 may define one or more parameters corresponding to the type(s) of data that are to be securely passed to the virtual machine instance through this secure communications protocol. In response to the API call, the virtual machine instance may determine, from the web DOM associated with the website 114, which portions of the website 114 may be encoded and streamed to the user 108. For example, returning to the illustrative example shown in FIG. 1, if the API call defines parameters corresponding to entry of the user's username and password, the virtual machine instance may identify, from the web DOM corresponding to the website 114, the data entry fields through which the user 108 may provide their username and password. These data entry fields may be encoded and transmitted according to the WSS protocol or other secure communications protocol to enable the user 108 to interact with the graphical facsimile of these data entry fields and provide their username and password securely to the virtual machine instance. However, if the user 108 does not transmit this API call to the virtual machine instance, the virtual machine instance may omit these data entry fields from the graphical facsimile of the website 114.

In an embodiment, the virtual machine instance implemented within the site rendering subnetwork of the secure web hosting platform 102, through the one or more software containers, translates the web DOM associated with the particular website 114 using one or more Web Real-Time Communication (WebRTC) protocols or through a Virtual Network Computing (VNC) protocol into a series of pixels that collectively represent a graphical facsimile of the website 114. The virtual machine instance may transmit a binary data stream that includes these pixels to a client (e.g., the computing device 110 associated with a requesting user 108, etc.), which may decode the binary data stream to compile the set of pixels into the graphical facsimile of the particular website 114 on the client, such as through a browser application 112. Since the particular website 114 is graphically represented using a set of pixels rather than through the web DOM associated with the particular website 114, inspection of the web DOM associated with the particular website 114 is prevented. For instance, because the graphical facsimile of the particular website 114 is generated through decoding of binary data streams from the virtual machine instance, a DOM inspector may be unable to process these binary data streams to inspect the web DOM associated with the particular website 114. This may prevent users from being able to evaluate the web DOM associated with the website 114 to identify any vulnerabilities associated with the website 114 or any other elements that may be exploited for malicious or other unauthorized purposes. Thus, through the translation of the web DOM associated with the website 114 using WebRTC or a VNC protocol into a series of pixels that graphically represent the website 114, the virtual machine instance may dynamically improve the security of the website 114, as users may be presented with a graphical facsimile of the website 114 that prevents inspection of the web DOM while making it difficult for these users to detect that they are being presented with a graphical facsimile of the website 114 through their browser applications.

The virtual machine instance implemented within the site rendering subnetwork and used to encode the web DOM associated with the website 114 (as obtained from the virtual machine instance implemented within the site hosting subnetwork) is instantiated such that only a virtual environment through which the data stream may be obtained is accessible to any authorized users. For instance, the virtual machine instance may include an operating system, a browser application, and a variety of other applications that may be executed to support the browser application and any other functionality required for the implementation of the virtual environment. The secure web hosting platform 102 may restrict access to the virtual machine instance instantiated for the virtual environment such that users may only be able to access the virtual environment. This may prevent users from accessing the operating system or any other application or functionality of the virtual machine instance not related to the virtual environment.

In an embodiment, the virtual machine instance utilized to implement the virtual environment through which the data stream may be transmitted is instantiated such that certain functionality of the virtual environment is restricted, prohibited, or otherwise inaccessible to users. For example, through the virtual environment, users may be prohibited from installing any browser extensions onto a virtual browser application implemented within the virtual environment. As another illustrative example, users may be prohibited from accessing any developer tools or other tools usually implemented by the virtual browser application that allow users to inspect and/or modify any presented assets (e.g., HTML code, Cascading Style Sheets (CSS), JavaScript code, applets, etc.). Further, as another illustrative example, the secure web hosting platform 102 may prohibit users from being able to inspect any web element or other element presented or otherwise available through the virtual browser application implemented within the virtual environment.

As the virtual machine instance within the site rendering subnetwork encodes the web DOM and the various assets associated with the website 114 according to either the default encoding method (e.g., one or more WebRTC protocols, a VNC protocol, etc.) or the custom encoding method defined by the secure web hosting platform 102, the virtual machine instance may push or transmit, in real-time, data that can be translated according to the used protocol into the graphical facsimile of the website 114. The browser application 112 may automatically, and in real-time, translate the encoded graphical facsimile of the website 114 and present the graphical facsimile of the website 114. The graphical facsimile of the website 114 may appear identical to the original website with some notable exceptions. For example, if the user 108 accesses, through the browser application 112, a browser menu corresponding to the presented graphical facsimile of the website 114, the option to inspect the website 114 may be disabled such that the user 108 is prohibited from inspecting the website 114. For instance, since the website 114 presented through the browser application 112 is a graphical facsimile of the website 114, the browser application 112 may automatically disable the option to inspect the website 114. In some instances, in addition to pushing or transmitting the data stream that includes the encoded graphical facsimile of the website 114, the virtual machine instance within the site rendering subnetwork may transmit executable instructions to the browser application 112 to disable this option to inspect the website 114.

In an embodiment, when a website owner 104 submits a request to the secure web hosting platform 102 to host a website 114 through a virtual machine instance in the site hosting subnetwork, the secure web hosting platform 102 automatically generates and assigns a unique identifier corresponding to the website 114. In some instances, the unique identifier is a universally unique identifier (UUID), which may also be referred to as a globally unique identifier (GUID). A UUID may be generated using any suitable technique for generating a unique identifier. A UUID may not be mathematically guaranteed to be unique, but may have a probability of being not unique that is low enough to be considered unique within the context of virtual machine instances and corresponding websites being hosted by the secure web hosting platform 102. As an example, the UUID generated by the secure web hosting platform 102 may be a version 4 UUID, which includes thirty-two hexadecimal characters representing 128 bits. In one or more embodiments, the bits that comprise the version 4 UUID are randomly generated. Therefore, there are 2128 possible combinations of bits, leaving the probability that two such generated UUIDs are the same very low within reasonable time and computation power constraints. A UUID used as the initial identifier may be generated using other techniques for UUID generation. For example, a version 1 UUID is generated based on a Media Access Control (MAC) address of a virtual machine instance (or component therein) in combination with an exact time of generation, which would not be duplicated unless the two UUIDs were generated using the same device, having the same MAC address, at the same time. Any other technique for generating a UUID may be used without departing from the scope of embodiments described herein.

In addition to generating a unique identifier corresponding to the website 114 in response to the request from a website owner 104, the secure web hosting platform 102 may automatically assign, by default, a Uniform Resource Identifier (URI) for the website 114 and that may be used by a user (such as user 108) to access the data stream for generating a graphical facsimile of the website 114. For instance, the secure web hosting platform 102 may dynamically generate a URI that encodes the unique identifier associated with the website 114 and generated in response to the request from the website owner 104. Alternatively, the secure web hosting platform 102 may generate a URI for the website 114 at random by default. In an embodiment, when the secure web hosting platform 102 assigns a URI to the website 114, the secure web hosting platform 102 updates one or more Domain Name System (DNS) servers to map the URI associated with the particular website 114 with an Internet Protocol (IP) address corresponding to the virtual machine instance instantiated to encode the web DOM associated with the particular website 114 into a graphical facsimile of the particular website 114 for users. For example, while the data (e.g., web DOM, assets, etc.) associated with a particular website 114 may reside within the virtual machine instance maintained by the secure web hosting platform 102 in the site hosting subnetwork, the URI corresponding to the particular website 114 may be mapped to an IP address associated with the virtual machine instance implemented by the secure web hosting platform 102 in the site rendering subnetwork. Further, the virtual machine instance in the site rendering subnetwork may be configured to automatically access the virtual machine instance in the site hosting subnetwork in response to a request to access the website to obtain the web DOM and other assets associated with the website 114 for encoding into the graphical facsimile of the website 114. Thus, if a user 108 enters, through a browser application implemented on their computing device 110, the URI corresponding to the particular website 114, the user 108 may be automatically directed to the virtual machine instance implemented by the secure web hosting platform 102 in the site rendering subnetwork.

In some instances, a website owner 104 may submit a request to the secure web hosting platform 102 to assign a particular URI to the website 114 that is to be hosted by the secure web hosting platform 102. In response to the request, the secure web hosting platform 102 may query the one or more DNS servers to determine whether the requested URI is available for the website 114. If the requested URI is assigned to another entity, the secure web hosting platform 102 may provide a response to the website owner 104 that the requested URI is not available. In some instances, if the requested URI is not available, the secure web hosting platform 102 may automatically generate a URI on behalf of the website owner 104. This automatically generated URI may encode the unique identifier associated with the website 114 or may be generated at random, as described above. If the requested URI is available, the secure web hosting platform 102 may update the one or more DNS servers to map the requested URI with the IP address corresponding to the virtual machine instance instantiated to encode the web DOM associated with the particular website 114 into a graphical facsimile of the particular website 114 for users.

The website owner 104, in some instances, may further submit a request to assign multiple URIs to the website 114. For example, a website owner 104 may seek to associate the website 114 with different variations of a particular URI in order to reduce the likelihood of website spoofing, domain name squatting, and the like by other entities. In response to this request, the secure web hosting platform 102 may query the one or more DNS servers to determine whether the requested URIs are available for the website 114. If so, the secure web hosting platform 102 may update the one or more DNS servers to map the requested URIs with the IP address corresponding to the virtual machine instance instantiated to encode the web DOM associated with the particular website 114 into a graphical facsimile of the particular website 114 for users. Alternatively, if the secure web hosting platform 102 determines that none of the requested URIs are available for the website 114, the secure web hosting platform 102 may automatically generate a URI on behalf of the website owner 104, as described above. However, if at least one of the requested URIs is available for the website 114, the secure web hosting platform 102 may forego generating alternative URIs for the website 114 in place of the unavailable URIs requested by the website owner 104.

In an embodiment, the secure web hosting platform 102 exposes an API through which the website owner 104 may deploy the web DOM and corresponding web assets 106 for the website 114 to the secure web hosting platform. The secure web hosting platform 102 may provide, to the website owner 104, a command line interface (CLI) through which the website owner 104 may submit a command line (e.g., an API call) to the exposed API to upload the web DOM and corresponding assets 106 associated with the website 114 to the secure web hosting platform 102. Through the command line, the website owner 104 may submit JavaScript Object Notation (JSON) data that the API exposed by the secure web hosting platform 102 may process. It should be noted that while JSON data is used extensively throughout the present disclosure for the purpose of illustration, other parsable formats may be used. The JSON data may specify at least a portion of the unique identifier corresponding to the website 114 and assigned to the website 114 by the secure web hosting platform 102. For example, in an embodiment, when the secure web hosting platform 102 generates the unique identifier for the website 114, the secure web hosting platform 102 may generate, from the unique identifier, a slug that may be used to represent the unique identifier assigned to the website 114. In some instances, the slug may include a portion of the unique identifier. In addition to this slug, the JSON data may further indicate the directory within which the web DOM and corresponding web assets 106 for the website 114 are maintained. The JSON data, in some instances, may further include authentication tokens that are associated with the website owner 104 and used by the secure web hosting platform 102 to authenticate the website owner 104.

In response to the command (e.g., API call) from the website owner 104 submitted through the CLI, the API deployed by the secure web hosting platform 102 may process the JSON data to identify the virtual machine instance to which the web DOM and corresponding web assets 106 are to be stored and used to implement the website 114. As the web DOM and web assets 106 are uploaded from the indicated directory to the secure web hosting platform 102, the API may automatically transfer the web DOM and web assets 106 to the virtual machine instance corresponding to the indicated slug. The virtual machine instance may automatically process the uploaded web DOM and web assets 106 to render the website 114 within the site hosting subnetwork. As noted above, users are prevented from accessing this virtual machine instance within the site hosting subnetwork. Instead, users may access a data stream that encodes a graphical facsimile of the website through a separate virtual machine instance implemented within the website rendering subnetwork.

When a user 108, through a browser application 112 implemented on their computing device 110, submits a request to access the website 114, the browser application 112 may transmit a request to the one or more DNS servers to obtain the IP address corresponding to the website 114. Accordingly, in response to the request from the browser application 112, the one or more DNS servers may return the IP address of the virtual machine instance within the website rendering subnetwork. Using this IP address, the browser application 112 may transmit a request to the virtual machine instance within the website rendering subnetwork to access the website 114. In response to the request to access the website 114, the virtual machine instance within the website rendering subnetwork may automatically, and in real-time, query the virtual machine instance associated with the website 114 in the site hosting subnetwork to obtain the web DOM and any other assets that may be used to render the website 114. The virtual machine instance within the website rendering subnetwork may automatically process the web DOM and the other web assets 106 to generate a graphical facsimile of the website 114 that may be streamed to the user 108 in response to their request. For instance, if using a default encoding mechanism (e.g., one or more WebRTC protocols, a VNC protocol, etc.), the virtual machine instance within the website rendering subnetwork may encode one or more portions of the web DOM associated with the particular website 114 into individual pixels that may be pushed or transmitted in a binary stream to the browser application 112. Alternatively, if the secure web hosting platform 102 implements a custom encoder for encoding of the one or more portions of the web DOM associated with the particular website 114 for delivery of the graphical facsimile of the website 114 to the user 108, the virtual machine instance within the website rendering subnetwork may process the web DOM associated with the particular website 114 using the custom encoder to generate an encoding in a data format that may be compressed, encrypted, and transmitted to the browser application 112 for presentation of a graphical facsimile of the website 114.

As the virtual machine instance within the website rendering subnetwork encodes the web DOM and the various web assets 106 associated with the website 114 according to either the default encoding method (e.g., one or more WebRTC protocols, a VNC protocol, etc.) or the custom encoding method defined by the secure web hosting platform 102, the virtual machine instance may push or transmit, in real-time, a data stream that includes the encoded graphical facsimile of the website 114. The browser application 112 may automatically, and in real-time, decode the encoded graphical facsimile of the website 114 and present the graphical facsimile of the website 114. The graphical facsimile of the website 114 may appear identical to the original website with some notable exceptions. For example, if the user 108 accesses, through the browser application 112, a browser menu corresponding to the presented graphical facsimile of the website 114, the option to inspect the website 114 may be disabled such that the user 108 is prohibited from inspecting the website 114. For instance, since the website 114 presented through the browser application 112 is a graphical facsimile of the website 114, the browser application 112 may automatically disable the option to inspect the website 114. In some instances, in addition to pushing or transmitting the data stream that includes the encoded graphical facsimile of the website 114, the virtual machine instance within the website rendering subnetwork may transmit executable instructions to the browser application 112 to disable this option to inspect the website 114.

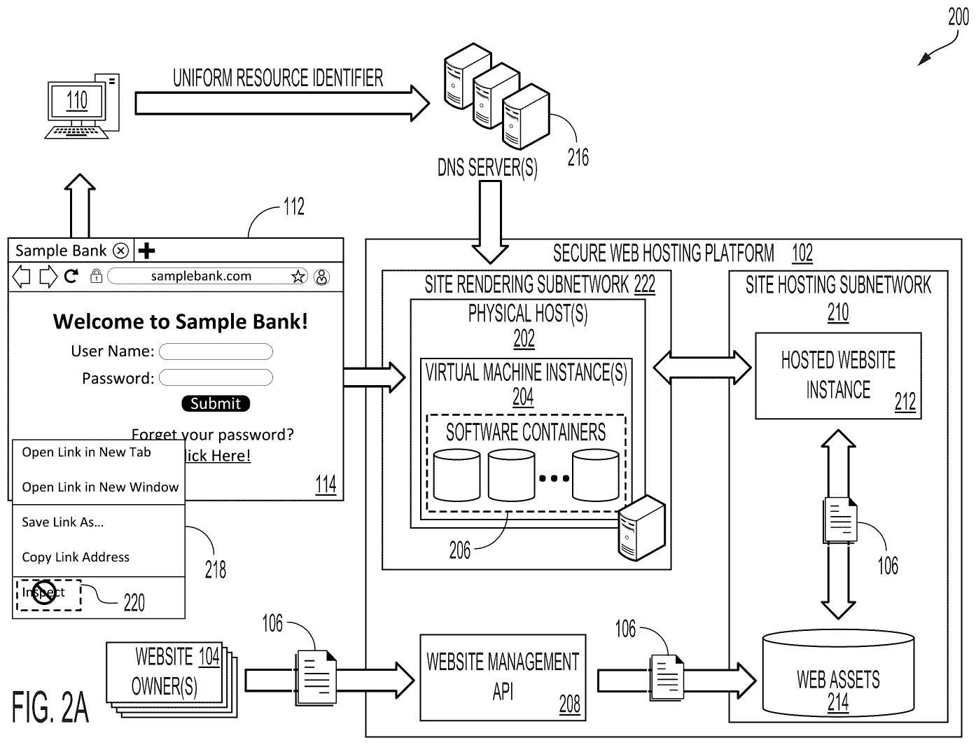

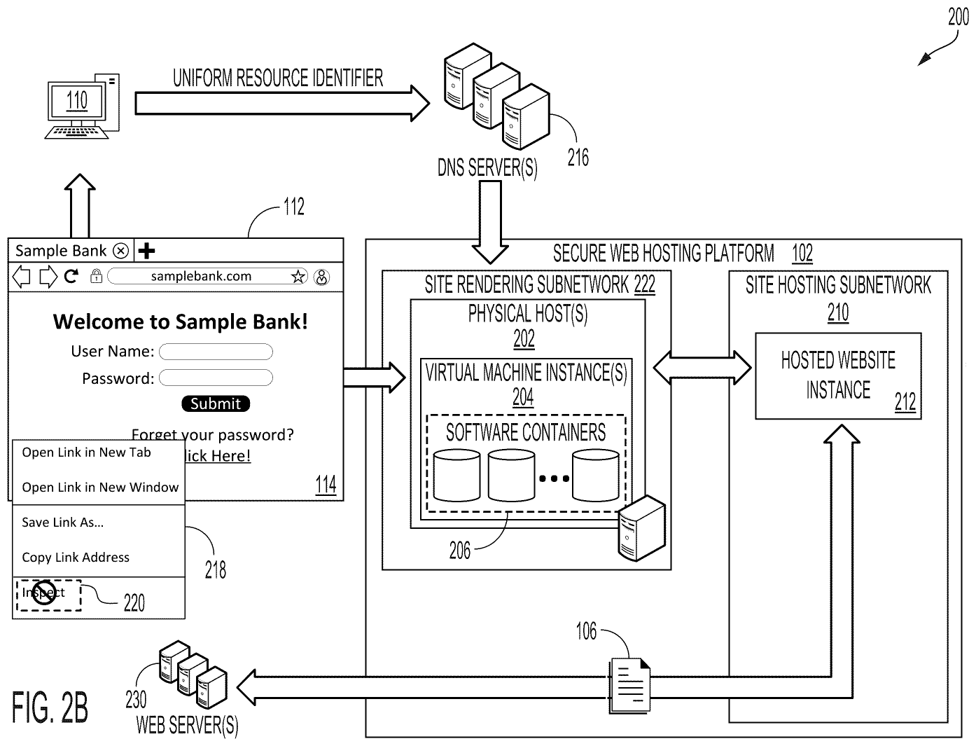

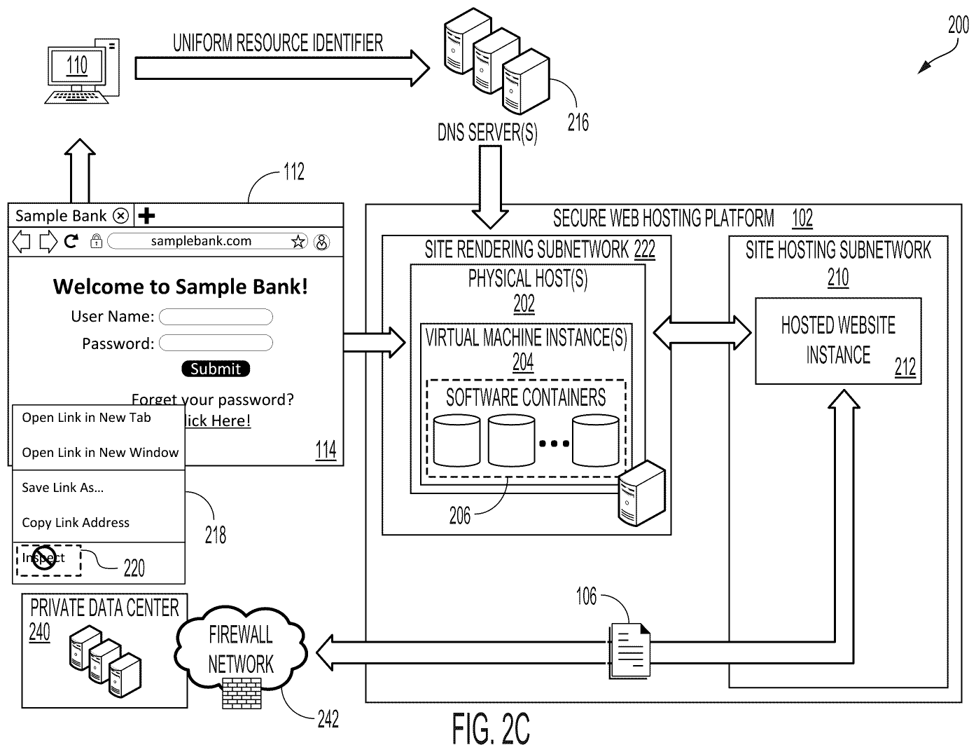

FIGS. 2A-2C show an illustrative example of an environment 200 in which a secure web hosting platform 102 hosts and renders a website 114 on behalf of a website owner 104 within a site hosting subnetwork 210 of the secure web hosting platform 102 through which users can access a graphical facsimile of the website 114 through virtual hosted browser applications implemented by the secure web hosting platform 102 in accordance with at least one embodiment. In the environment 200, and as illustrated in FIG. 2A, a website owner 104 may access the secure web hosting platform 102 to configure a website 114 that may be hosted by the secure web hosting platform 102 and that may be automatically translated into a graphical facsimile of the website 114 for presentation of the website 114 to users in response to requests to access the website 114. For instance, the secure web hosting platform 102, in response to a request to configure a website 114 that may be hosted by the secure web hosting platform 102 on behalf of the website owner 104, may provide the website owner 104 with various configuration options for a hosted website instance 212 through which a virtual environment may be implemented for hosting the website 114 within a site hosting subnetwork 210. Additionally, the secure web hosting platform 102 may provide the website owner 104 with various configuration options for a virtual machine instance 204 (e.g., a website rendering instance) through which a virtual environment may be implemented for translating the website 114 into a graphical representation of the website 114 that may be transmitted to users requesting access to the website.

In response to the request, the secure web hosting platform 102 may determine, for the virtual environment through which the website 114 is to be translated, the available capacity for each of the physical hosts 202 maintained by the secure web hosting platform 102. Further, the secure web hosting platform 102 may query a virtual machine image repository to identify the available virtual machine images that may be used to instantiate the virtual environment on to a physical host 202. Based on this information, the secure web hosting platform 102 may determine which virtual machine images may be used to instantiate a virtual environment on to a physical host having the available capacity to support the virtual environment. The secure web hosting platform 102 may present, to the website owner 104, the available virtual machine images that may be instantiated onto available capacity of the physical hosts 202 for a virtual environment through which the website 114 may be translated.

The secure web hosting platform 102 may further determine, for the hosted website instance 212, the available capacity for each of the physical hosts maintained within the site hosting subnetwork 210. Additionally, the secure web hosting platform 102 may query a virtual machine image repository to identify the available virtual machine images that may be used to instantiate the hosted website instance 212 on to a physical host within the site hosting subnetwork 210. Similar to the process for instantiating a virtual machine instance 204 for translating the website 114 into a graphical facsimile of the website 114, the secure web hosting platform 102 may determine which virtual machine images may be used to instantiate a hosted website instance 212 on to a physical host having the available capacity to support the hosted website instance 212. The secure web hosting platform 102 may also present, to the website owner 104, the available virtual machine images that may be instantiated onto available capacity of the physical hosts within the site hosting subnetwork 210 for the hosted website instance 212.

In an embodiment, the secure web hosting platform 102 allows the website owner 104 to define a set of configuration options for the hosted website instance 212. For example, the website owner 104 may specify that the hosted website instance 212 for the website 114 is to have a minimum amount of RAM, a minimum number of vCPUs, minimum storage capacity, a minimum amount of available bandwidth, and the like. Further, in some instances, the secure web hosting platform 102 may provide the website owner 104 with options corresponding to different browser applications that can be implemented within the hosted website instance 212 for rendering of the website 114. For instance, a website owner 104 may select an option to have the hosted website instance 212 render the website 114 through a Google Chrome™ browser application implemented by the hosted website instance 212 as opposed to Microsoft Edge®, Mozilla Firefox®, or any other available browser application that may be implemented by the hosted website instance 212. Alternatively, the website owner 104 may specify that it is agnostic as to which browser application is implemented by the hosting website instance 212 for rendering the website 114 within the hosted website instance 212 so long as the minimum configuration requirements for the website 114 are satisfied. In some instances, the particular browser application implemented for rendering the website 114 is fixed by the secure web hosting platform 102.

If the website owner 104 provides a set of configuration requirements for the hosted website instance 212, the secure web hosting platform 102 may determine whether these requirements may be satisfied using the available capacity of the physical hosts within the site hosting subnetwork 210 and a virtual machine image that, when instantiated, provides the required functionality requested by the website owner 104. For instance, the secure web hosting platform 102 may determine, based on an evaluation of the physical hosts within the site hosting subnetwork 210, the available capacity of the physical hosts for instantiation of the hosted website instance 212. If the available capacity does not satisfy the website owner's configuration requirements, the secure web hosting platform 102 may reject the request. Alternatively, the secure web hosting platform 102 may queue the administrator's request until a physical host within the site hosting subnetwork 210 becomes available that has sufficient available capacity to satisfy the website owner's configuration requirements.

In some instances, the secure web hosting platform 102 may further identify any available virtual machine images that may be used to instantiate the hosted website instance 212 on to a physical host within the site hosting subnetwork 210 according to the website owner's configuration requirements. For instance, a virtual machine image may have a corresponding set of configuration requirements for instantiation, whereby these configuration requirements may represent an average level of performance for a hosted website instance 212 instantiated using the virtual machine image. Thus, the secure web hosting platform 102 may identify any virtual machine images that satisfy the website owner's configuration requirements. The secure web hosting platform 102 may present these virtual machine images to the website owner 104 to allow the website owner 104 to select a virtual machine image that may be instantiated onto a physical host within the site hosting subnetwork 210 to implement the hosted website instance 212.

In a similar manner, the secure web hosting platform 102 may instantiate a virtual machine instance 204 within a site rendering subnetwork 222 and through which the website 114 may be encoded into a data stream for presentation to users. For instance, the secure web hosting platform 102 allows the website owner 104 to define a set of configuration options for the virtual machine instance 204. If the website owner 104 provides a set of configuration requirements for the virtual machine instance 204, the secure web hosting platform 102 may determine whether these requirements may be satisfied using the available capacity of the physical hosts 202 within the site rendering subnetwork 222 and a virtual machine image that, when instantiated, provides the required functionality requested by the website owner 104. The secure web hosting platform 102 may further identify any available virtual machine images that may be used to instantiate the virtual machine instance 204 on to a physical host 202 within the site rendering subnetwork 222 according to the website owner's configuration requirements. Based on the website owner's selections, the secure web hosting platform 102 may instantiate a virtual machine image within a physical host 202 to implement a virtual machine instance 204 in the site rendering subnetwork 222 that may encode the website 114 rendered through the hosted website instance 212.

The virtual machine instance 204 may include an operating system, a browser application, and a variety of other applications that may be executed to support a browser application and any other functionality required for the implementation of the virtual environment through which the website 114 rendered by the hosted website instance 212 is encoded into a data stream. The secure web hosting platform 102 may restrict access to the virtual machine instance 204 instantiated for the virtual environment such that users may only be able to access the virtual environment and the data stream. However, users may not have any direct access to the hosted website instance 212 and the site hosting subnetwork 210. The site hosting subnetwork 210, in an embodiment, is a private subnetwork of the secure web hosting platform 102 that is not readily accessible through any public communications networks, such as the Internet. The virtual machine instance 204 may have access to the hosted website instance 212 solely to translate the website 114 rendered by the hosted website instance 212 using the web DOM and corresponding web assets 106 associated with the website 114. However, due to the isolation of the different functionalities of the virtual machine instance 204 (as described in greater detail herein), users do not have access to this encoding process performed through the hosted website instance 212. In an embodiment, the hosted website instance 212 within the site hosting subnetwork 210 can access other systems through public communications networks to, for example, make API calls to a website owner's computing environment through an API maintained by the website owner 104. This API may be peered into the private site hosting subnetwork 210. However, the website owner 104, through this API, may be unable to receive any ingress traffic of the site hosting subnetwork 210.

In an embodiment, the virtual machine instance 204 is instantiated as a container instance that is configured to operate myriad software containers 206 according to the parameters of the virtual machine image. The virtual machine instance 204 may include a set of software containers 206 that may execute in isolation from each other (e.g., a software container may have an isolated view of a file system, users and groups, processes, etc.). A software container 206 may operate under the virtual machine instance 204 and can include one or more applications or programs, data, system libraries, and the like. Further, when a software container 206 is executed, the one or more applications or programs executed therein may be isolated from other applications or programs being executed within the virtual machine instance 204. For instance, the myriad software containers 206 implemented in the virtual machine instance 204 may each operate on an operating system (using the computing resources allocated to the software container 206) in isolation from one another. For instance, an encoder implemented to translate the web DOM associated with a particular website using one or more protocols (e.g., WebRTC, VNC, etc.) into a series of pixels may be executed on a software container isolated from a data transmitter operating within the virtual machine instance 204 for transmitting the graphical facsimile of the website 114 to users. The virtual machine instance 204 may implement a software container for the operating system, a software container that encodes the web DOM for the website 114 hosted in the hosted website instance 212 into a series of pixels, a software container for personal settings, and the like.

The software container used to implement the encoder may be configured to only have limited access to the hosted website instance 212 and resources available via other software containers of the virtual machine instance 204. Thus, the software container may be executed to have access to only the hosted website instance 212 for translating the website 114 and to certain resources from the computing resources allocated for the virtual machine instance 204. Due to this isolation, a user may only be able to access the graphical facsimile of the website 114 provided by the encoder. This may prevent users from accessing the hosted website instance 212 and the operating system, file systems, and other resources associated with the virtual machine instance 204, providing an additional layer of security for the virtual environment. Further, this level of isolation may prevent cross-tenant access to other software containers implemented by the secure web hosting platform 102.

In an embodiment, the virtual machine instance 204, through the one or more software containers 206, translates the web DOM associated with the website 114 using one or more protocols (e.g., WebRTC, VNC, etc.) into a series of pixels. The virtual machine instance 204 may transmit a binary data stream that includes these pixels to a client (e.g., the computing device 110 associated with a requesting user, etc.), which may decode the binary data stream to compile the set of pixels into the graphical facsimile of the website 114 on the client, such as through a browser application 112. Since the website 114 is graphically represented using a set of pixels rather than through the web DOM associated with the website 114, inspection of the web DOM associated with the website 114 is prevented. For instance, because the graphical facsimile of the website 114 is generated through decoding of binary data streams from the virtual machine instance 204, a DOM inspector may be unable to process these binary data streams to inspect the web DOM associated with the website 114.

In an embodiment, the secure web hosting platform 102 can define a custom data structure that may be used to encode one or more portions of the web DOM associated with the website 114. For example, the secure web hosting platform 102 may define a custom encoder that may be used by the virtual machine instance 204 (such as through one or more software containers 206) to encode one or more portions of the web DOM. In some instances, the custom encoder may be implemented to encode text and a binary image associated with the website 114 into a data format that may be compressed and encrypted for delivery to a client. The client (which is provided with the cryptographic key(s) for decrypting the data stream from the virtual machine instance 204) may decrypt and decompress the data stream comprising the encoded text and binary image. Further, the client may decode the text and binary image to render the graphical facsimile of the website 114 according to the preferences defined by the secure web hosting platform 102 through definition of the custom encoder. In some instances, the decoder provided to the client for decoding the encoded text and binary image may be defined through custom JavaScript libraries and/or other libraries defined using appropriate programming languages.

In an embodiment, the secure web hosting platform 102 can provide the website owner 104 with one or more options corresponding to different protocols that may be used to translate one or more portions of the web DOM associated with the website 114 into a graphical facsimile of the website 114. For example, the website owner 104 may be provided, through an interface, with a set of protocols made available by the secure web hosting platform 102 for encoding the website 114 according to any of the aforementioned methods. For instance, through this interface, the secure web hosting platform 102 may present the website owner 104 with options to utilize a WebRTC protocol, a VNC protocol, a codec, any custom protocols or encoders defined by the secure web hosting platform 102, and the like for encoding of the website 114. Further, through the interface, the secure web hosting platform 102 may provide the website owner 104 with various options with regard to the portions of the website 114 that are to be translated according to a selected protocol. For example, the secure web hosting platform 102, through the virtual machine instance 204 and the hosted website instance 212, may render and translate the website 114 according to the web DOM and corresponding scripts and assets associated with the website 114 through a virtual environment. In some instances, the secure web hosting platform 102 may allow a website owner 104 to indicate, via data attributes, what portions of the website 114 are to the be translated into graphical facsimiles of these portions of the website 114, as well as the corresponding protocols, codecs, and/or encoders are to be used for translating these portions of the website 114. Through the virtual environment, the different portions of the website 114 may be indicated such that the website owner 104 may readily discern which portions of the website 114 correspond to the different portions of the web DOM. Further, through the virtual environment, the website owner 104 may select which portions of the website 114 are to be translated into graphical facsimiles of these portions of the website 114. Based on this selection, the virtual machine instance 204 may automatically identify the corresponding portions of the web DOM, as well as the corresponding assets and scripts, that are to be encoded according to the selected encoding protocol.

As noted above, when a website owner 104 submits a request to the secure web hosting platform 102 to host a website 114 within a hosted website instance 212 in the site hosting subnetwork 210, the secure web hosting platform 102 may automatically generate and assign a unique identifier (e.g., UUID, GUID, etc.) to the hosted website instance 212 and the website 114. In addition to generating a unique identifier corresponding to the hosted website instance 212 and the website 114, the secure web hosting platform 102 may automatically assign a URI to the website 114. This URI may be used by a user to access the virtual machine instance 204 and obtain the data stream for generating a graphical facsimile of the website 114. In some instances, the URI may embed the unique identifier assigned to the hosted website instance 212 and the website 114. For example, the URI may include, as the subdomain, the unique identifier or a slug associated with the unique identifier. The URI may include, as the second-level domain, the entity name of the secure web hosting platform 102. In some instances, the URI may be generated at random. For example, if the URI includes a subdomain and second-level domain, these domains may be defined at random by the secure web hosting platform 102.

Once the secure web hosting platform 102 has generated a URI for the website 114, the secure web hosting platform 102 may update one or more DNS servers 216 to map the URI for the website 114 to the IP address of the virtual machine instance 204 instantiated to encode the web DOM and corresponding web assets 106 from the hosted website instance 212 into a graphical facsimile of the website 114. For example, web DOM and corresponding web assets 106 associated with the website 114 may be provided by the hosted website instance 212 in the site hosting subnetwork 210, the URI corresponding to the website 114 may be mapped to an IP address associated with the virtual machine instance 204 in the site rendering subnetwork 222. Further, the virtual machine instance 204 may be configured to automatically access the hosted website instance 212 in response to a request to access the website 114 to encode the web DOM and other assets associated with the website 114 into the graphical facsimile of the website 114. Thus, if a user enters, through a browser application implemented on their computing device 110, the URI corresponding to the website 114, the user may be automatically directed to the virtual machine instance 204 to obtain the data stream corresponding to the encoded graphical facsimile of the website 114.

The secure web hosting platform 102, in some instances, may allow the website owner 104 to request a specific URI for their website 114. If the website owner 104 requests a specific URI for their website 114, the secure web hosting platform 102 may query the one or more DNS servers 216 to determine whether the specified URI is available for the website 114. If the URI is assigned to another entity or is otherwise unavailable, the secure web hosting platform 102 may transmit a notification to the website owner 104 indicating that the URI is not available for the website 114. In some instances, if the requested URI is not available, the secure web hosting platform 102 may automatically assign a URI to the website 114, as described above. If the URI requested by the website owner 104 is available, the secure web hosting platform 102 may update the one or more DNS servers 216 to map the requested URI to the IP address corresponding to the virtual machine instance 204 in the site rendering subsystem 222.

To allow for configuration of the website 114 through the hosted website instance 212, the secure web hosting platform 102 may implement a website management API 208 through which the website owner 104 may upload the web DOM and corresponding web assets 106 to a web assets datastore 214 within the site hosting subnetwork 210. The secure web hosting platform 102 may provide, to the website owner 104, a CLI through which the website owner 104 may submit a command (e.g., an API call) to the website management API 208 to upload the web DOM and corresponding web assets 106 associated with the website 114 to the web assets datastore 214. Through the CLI, the website owner 104 may submit data that the website management API 208 may process. The data may specify at least a portion of the unique identifier assigned to the website 114 by the secure web hosting platform 102. For example, in an embodiment, when the secure web hosting platform 102 generates the unique identifier for the website 114, the secure web hosting platform 102 may generate, from the unique identifier, a slug that may be used to represent the unique identifier assigned to the website 114. In some instances, the slug may include a portion of the unique identifier. In addition to this slug, the data may further indicate the directory within which the web DOM and corresponding web assets 106 for the website 114 are maintained. This directory may be maintained within the web owner's computing environment.

In response to the API call from the website owner 104 submitted through the CLI, the website management API 208 may process the data to identify the hosted website instance 212 for which the web DOM and corresponding web assets 106 are to be stored in the web assets datastore 214 and used to implement the website 114. As the web DOM and web assets 106 are uploaded from the indicated directory to the web assets datastore 214, the website management API 208 may automatically transfer the web DOM and web assets 106 to the hosted website instance 212 for rendering of the website 114. The hosted website instance 212 may automatically process the uploaded web DOM and web assets 106 to render the website 114 within the site hosting subnetwork 210.

When a user, through a browser application 112 implemented on their computing device 110, submits a request to access the website 114 (such as through entry of a URI corresponding to the website 114 through their browser application 112), the browser application 112 may transmit a request to the one or more DNS servers 216 to obtain the IP address corresponding to the website 114. As noted above, the secure web hosting platform 102 may update the one or more DNS servers 216 to map the URI corresponding to the website 114 to an IP address corresponding to the virtual machine instance 204 implemented to convert the web DOM and other web assets 106 associated with the website 114 into a graphical facsimile of the website 114 that may be streamed to the user's computing device 110. Accordingly, in response to the request from the browser application 112, the one or more DNS servers 216 may return the IP address of the virtual machine instance 204. Using this IP address, the browser application 112 may transmit a request to the virtual machine instance 204 to access the website 114.

In response to the request to access the website 114, the virtual machine instance 204 may automatically, and in real-time, query the hosted website instance 212 associated with the website 114 to obtain the web DOM and any other web assets 106 that may be used to render the website 114. The virtual machine instance 204, using the one or more software containers 206 described above and implemented therein, may automatically process the web DOM and the other web assets 106 to generate a graphical facsimile of the website 114 that may be transmitted to the user in response to their request. For instance, if using a default encoding mechanism (e.g., one or more WebRTC protocols, a VNC protocol, etc.), the one or more software containers 206 may encode one or more portions of the web DOM associated with the website 114 into individual pixels that may be pushed or transmitted in a binary stream to the browser application 112. Alternatively, if the secure web hosting platform 102 implements a custom encoder for encoding of the one or more portions of the web DOM associated with the website 114 for delivery of the graphical facsimile of the website 114 to the user, the one or more software containers 206 may process the web DOM associated with the website 114 using the custom encoder to generate an encoding in a data format that may be compressed, encrypted, and transmitted to the browser application 112 for presentation of a graphical facsimile of the website 114.

In an embodiment, in response to the request to access the website 114, the virtual machine instance 204 automatically queries the browser application 112 or other application that is to present the graphical facsimile of the website 114 to determine whether a decoder is available for decoding the encoded data stream corresponding to the graphical facsimile of the website 114. For instance, the virtual machine instance 204 may transmit data that indicates the particular protocol or data format being utilized for encoding the web DOM according to the particular protocol or data format for creation of the graphical facsimile of the website 114. If the browser application 112 or other application does not have the requisite decoder for decoding an encoded data stream corresponding to the graphical facsimile of the website 114, the virtual machine instance 204 may transmit the appropriate decoder to the browser application 112 or other application for implementation of the decoder. Alternatively, the virtual machine instance 204 may transmit executable instructions to the browser application 112 or other application that, when executed, may cause the browser application 112 or other application to obtain the decoder from another network address or location.

In an embodiment, as illustrated in FIG. 2B, a website owner may configure the hosted website instance 212 to serve as a proxy of the website 114 in order to translate the web DOM associated with the website 114 into a graphical facsimile of the website 114 according to the protocols, codecs, and/or encoders selected by the website owner. The web DOM and web assets 106 associated with the website 114, in this instance, may reside within one or more web servers 230 maintained by the website owner. The website owner may provide, through the configuration of the hosted website instance 212, the one or more network addresses corresponding to the one or more web servers 230 that maintain the web DOM and corresponding web assets 106 associated with the website 114. In response to a user request to access the website 114, the virtual machine instance 204 may automatically, and in real-time, query the hosted website instance 212 associated with the website 114 to obtain the web DOM and any other web assets 106 that may be used to render the website 114. The hosted website instance 212, in response to this query, may access the one or more web servers 230 associated with the website owner to obtain the web DOM and other web assets 106 associated with the website 114. Once the hosted website instance 212 has obtained the web DOM and other web assets 106 from the one or more web servers 230, the hosted website instance 212 may provide the web DOM and other web assets 106 to the virtual machine instance 204 for rendering and translation of the website 114 into a graphical facsimile of the website 114.

In an embodiment, as illustrated in FIG. 2C, the hosted website instance 212 can access sensitive information maintained through a private data center 240 and that may be rendered through one or more whitelisted virtual machine instances 204 implemented by the site web hosting platform 102. In this particular instance, a website owner may define a set of configuration requirements whereby certain data (e.g., particular websites, data sources, etc.) may be accessed from a private data center 240 associated with the website owner only through whitelisted virtual machine instances or other resources (e.g., particular types of physical hosts 202, etc.). Further, for these whitelisted virtual machine instances or other resources, the website owner may define a set of access control policies that may define which users may access this certain data through whitelisted virtual machine instances or other resources. For example, the website owner may indicate which users are granted access to the indicated data (e.g., website 114) through the whitelisted virtual machine instances or other resources. If a user attempts to access the website 114 through a virtual machine instance 204, and the user is not designated as being permitted to access this website 114, the user may be immediately denied access to the website 114 through the virtual machine instance 204. In some instances, in order to access the website 114, the user may be required to provide a set of credentials (e.g., X.509 certificates, Secure Sockets Layer (SSL) certificates, authentication tokens, etc.) to the whitelisted virtual machine instance 204. If the provided set of credentials is valid, the user may be granted access to a graphical facsimile of the website through the virtual machine instance 204.

The configuration requirements for the website 114 may indicate that, in order to access the servers and/or datastores associated with the private data center 240 for retrieval of the web DOM and corresponding web assets 106 for the website 114, the hosted website instance 212 and the virtual machine instance 204 can only be implemented using whitelisted virtual machine instances or other resources (e.g., particular types of physical hosts 202, etc.). Network information associated with these whitelisted virtual machine instances or other resources may be used to configure a firewall network 242 or other secure network associated with the private data center 240 such that when a request to access the servers or datastores associated with private data center 240 is received at the firewall network 242, the firewall network 242 may determine whether to allow network traffic between the private data center 240 and the hosted website instance 212 used to obtain the web DOM and corresponding web assets 106 for rendering of the website 114. If the hosted website instance 212 and the virtual machine instance 204 have been whitelisted through the generated configuration information for the virtual machine instances, the firewall network 242 may facilitate transmission of network traffic from the private data center 240 (e.g., the servers, the datastores, etc.) to the hosted website instance 212, and vice versa.

If a user submitting a request to access the website 114 is successfully authenticated by the virtual machine instance 204 and is authorized to access the website 114, the virtual machine instance 204 may transmit a request to the hosted website instance 212 to retrieve the web DOM and corresponding web assets 106 for the website 114. In response to this request, the hosted website instance 212 may query the private data center 240, through the firewall network 242, to obtain the web DOM and corresponding web assets 106. The hosted website instance 212 may provide the web DOM and corresponding web assets 106 to the virtual machine instance 204, which may render the web DOM and corresponding web assets 106 for the website 114. The virtual machine instance 204 may further translate or otherwise convert the website 114 into a graphical facsimile of the website 114 that may be transmitted to the user and presented through the user's browser application 112.

In an embodiment, the website owner can define a set of configuration requirements whereby the website 114 may only be rendered and transmitted to certain authorized users through one or more whitelisted virtual machine instances 204 or other resources (e.g., particular types of physical hosts 202, etc.). As noted above, a website owner may define a set of access control policies that may define which authorized users may access the website 114 through whitelisted virtual machine instances or other resources. For instance, if an unauthorized user, through their browser application, enters the URI corresponding to the website 114 indicated through this set of access control policies, the virtual machine instance 204 may determine that the unauthorized user has not been granted access to the website 114 (e.g., the unauthorized user has not provided valid credentials, etc.). Accordingly, the virtual machine instance 204 may automatically return an error or other indication that the unauthorized user has not been granted access to the website 114 (e.g., an HTTP 404-File Not Found error, etc.).

In some instances, the website owner may define a set of access control policies that may define what portions of the website 114 are only available to authorized users. For instance, through the set of access control policies, the website owner may define portions of the web DOM associated with the website 114 that are to be presented only to authorized users. For instance, while the website 114 may be available to any user entering the URI associated with the website 114 into their browser application 112, only authorized users that submit a valid set of credentials may be presented with these portions of the website 114. Thus, based on these access control policies and the identity of the user attempting to access the website 114, the virtual machine instance 204 may determine what portions of the website are to be rendered and translated into a graphical facsimile for dissemination to the user through their browser application 112.

As the virtual machine instance 204 translates or otherwise converts the web DOM and the various assets associated with the website according to either the default encoding method (e.g., one or more WebRTC protocols, a VNC protocol, etc.) or the custom encoding method defined by the secure web hosting platform 102, the virtual machine instance 204 may push or transmit, in real-time, data that includes the encoded graphical facsimile of the website. The browser application 112 may automatically, and in real-time, decode the encoded graphical facsimile of the website and present the graphical facsimile of the website 114. The graphical facsimile of the website 114 may appear identical to the original website with some notable exceptions. For example, as illustrated in FIGS. 2A-2C, if the user accesses, through the browser application 112, a browser menu 218 corresponding to the presented graphical facsimile of the website 114, the option 220 to inspect the website 114 may be disabled such that the user is prohibited from inspecting the website 114 being presented to the user. For instance, since the website 114 presented through the browser application 112 is actually a graphical facsimile of the website 114, the browser application 112 may automatically disable the option 220 to inspect the website 114. In some instances, in addition to pushing or transmitting the data stream that includes the encoded graphical facsimile of the website 114, the virtual machine instance 204 may transmit executable instructions to the browser application 112 to disable this option 220 to inspect the website 114. It should be noted that while an option 220 to inspect the website is illustrated in FIGS. 2A-2C and used extensively throughout the present disclosure for the purpose of illustration, other options that may otherwise be made available to users accessing the website 114 (e.g., an option to save the website 114 as a document, an option to add or otherwise install browser extensions, etc.) may also be automatically disabled.

In an embodiment, because the website 114 is being rendered through a data stream that encodes a graphical facsimile of the website 114 through the browser application 112, the web DOM corresponding to this graphical facsimile of the website 114 does not include any of the data included in the original web DOM associated with the website 114. Thus, in some instances, if the option 220 is preserved, selection of the option 220 may result in presentation of a web DOM that includes no data corresponding to the actual website 114. Instead, the web DOM corresponding to the graphical facsimile of the website 114 may indicate that presented website is actually a graphical facsimile of the website 114 and, thus, no data corresponding to the underlying website 114 can be presented. This may prevent automated scripts (e.g., bots, etc.) or other tools from scraping any sensitive data from the website 114 and/or circumvent any measures implemented on the website 114 that are used to provide the appropriate user experience on the website 114. Further, because the web DOM and corresponding web assets 106 are maintained within the private site hosting subnetwork 210, the likelihood of the web DOM and corresponding web assets 106 being exposed to unauthorized entities is reduced.

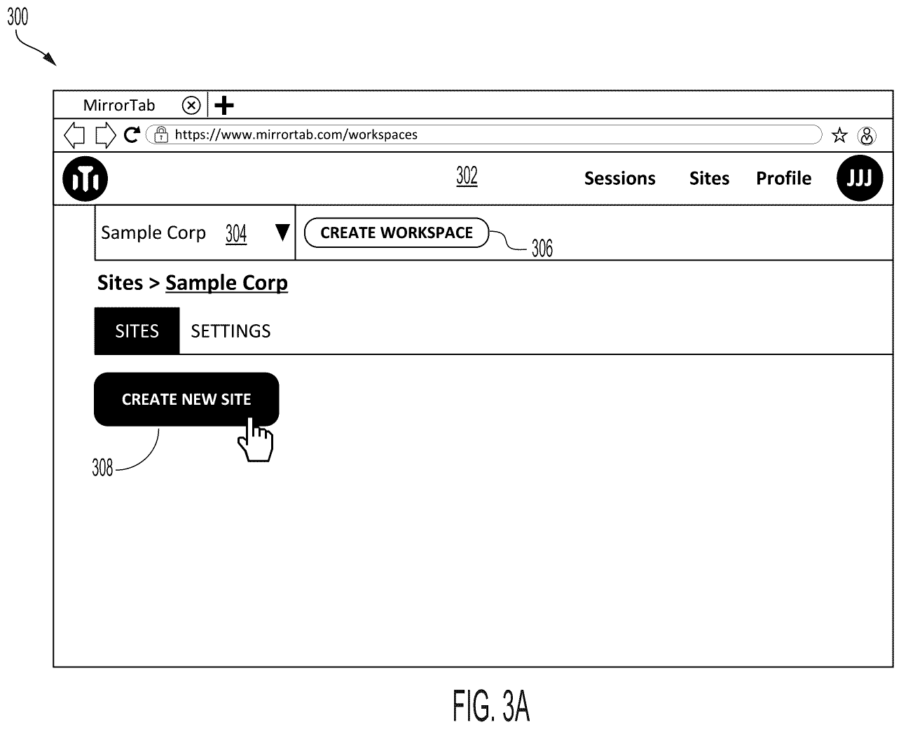

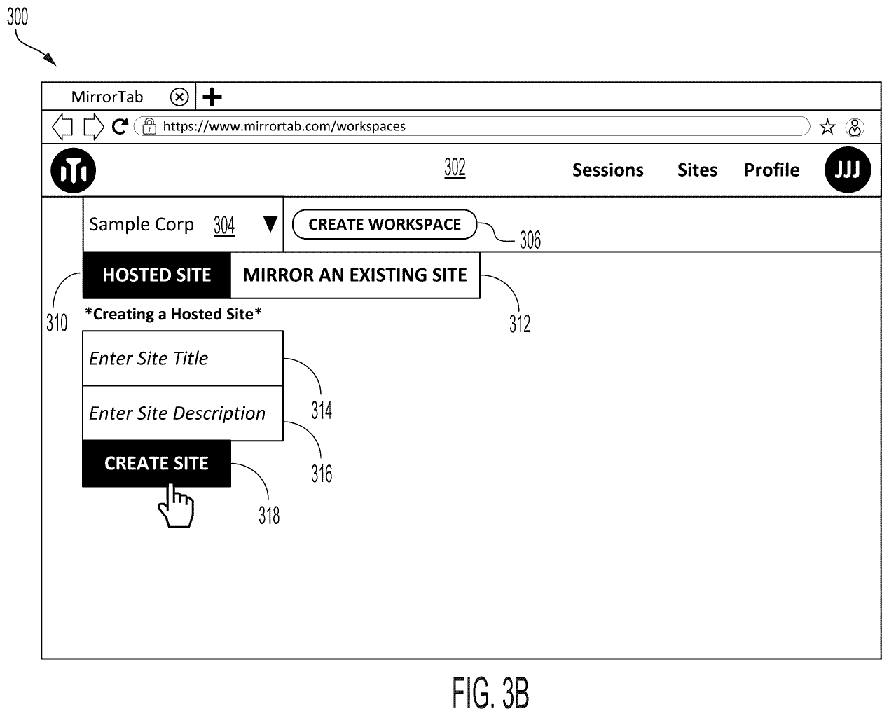

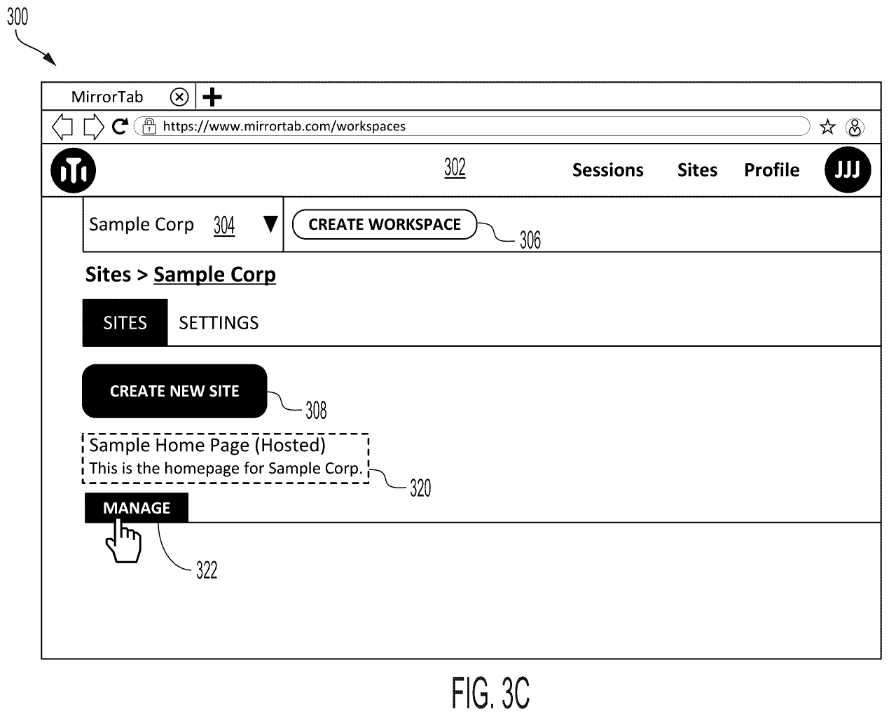

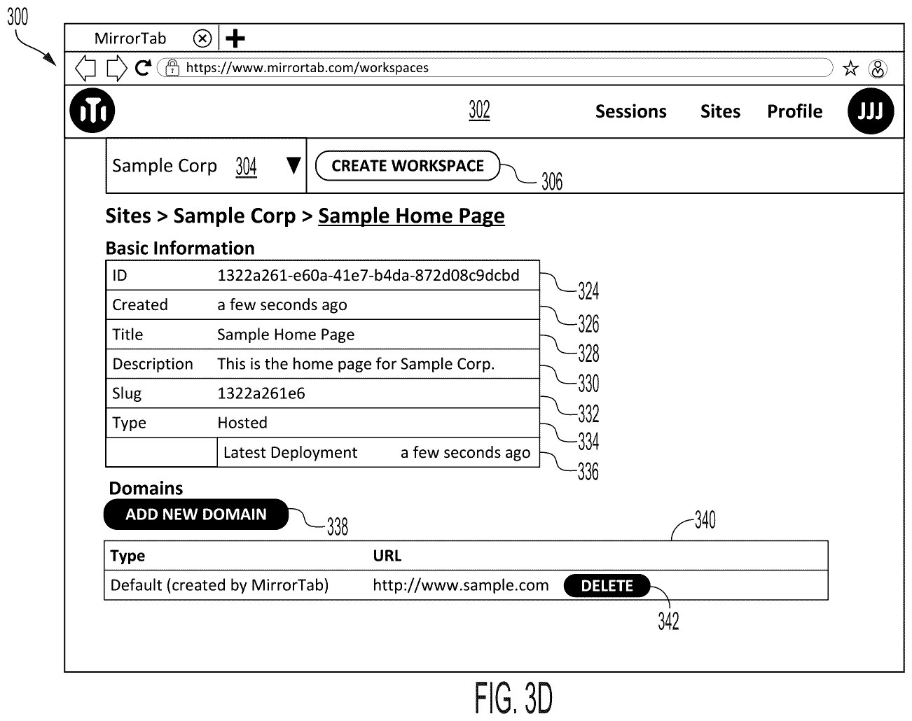

FIGS. 3A-3D show an illustrative example of an interface 300 through which a website owner configures a website to be hosted through the secure web hosting platform in accordance with at least one embodiment. As noted above, the secure web hosting platform may provide an interface 300 through which website owners may generate a workspaces for deploying websites to the secure web hosting platform. Through this interface, a website owner may submit a request to provision a virtual machine instance within the site hosting subnetwork of the secure web hosting platform and through which a particular website may be hosted. As illustrated in FIG. 3A, the interface 300 may be accessed through a browser application implemented on a website owner's computing device. In some instances, the interface 300 may be accessed through a native application implemented by the secure web hosting platform and executed on a website owner's computing device.

The interface 300, as illustrated in FIG. 3A, includes a secure web hosting platform main window 302, through which a website owner may access different functionalities of the secure web hosting platform. For example, the secure web hosting platform main window 302 may include an option to review or otherwise access any active sessions corresponding to different virtual machine instances through which different virtual environments are implemented. These different virtual environments may correspond to isolated virtual browser applications executed within the virtual machine instances and through which authorized users may access particular websites according to a set of applicable policies. For instance, a particular policy may define which websites may be accessed through a virtual browser application implemented within a particular virtual environment. As another illustrative example of a policy that may be implemented for a virtual environment, a policy may define what actions a user may perform within the virtual environment and the corresponding virtual browser application (e.g., input text into the browser application, select interaction elements of the browser application, etc.).

The secure web hosting platform main window 302 may further provide website owners with an option to review or otherwise manage different websites that are either hosted by the secure web hosting platform or that are mirrored through a virtual machine instance implemented by the secure web hosting platform (e.g., the web DOM and corresponding assets for a website are retrieved from external web servers and are rendered by the virtual machine instances to generate a graphical facsimile of the website). As described in greater detail herein, the web owner may select this option to initiate a request to the secure web hosting platform to host a website through a hosted website instance maintained by the secure web hosting platform in a private site hosting subnetwork.

Website owners, through the secure web hosting platform main window 302, may further be provided with an option to manage their profiles as maintained by the secure web hosting platform. For instance, a website owner may select this option to manage their account with the secure web hosting platform (e.g., contact information, payment information, physical addresses, electronic addresses, etc.). Further, the website owner may select this option to generate profiles corresponding to other users that may be authorized to access the website owner account for managing any websites that are either hosted by the secure web hosting platform or that are mirrored through a virtual machine instance implemented by the secure web hosting platform. Further, the website owner, through selection of this option, may define any policies that may be applied to the virtual machine instances provisioned for the website owner.

As illustrated in FIG. 3A, when a website owner selects the option to review or otherwise manage their websites, the secure web hosting platform may update the secure web hosting platform main window 302 to present a set of tabs 304 corresponding to different workspaces through which the website owner may manage their websites. For example, the website owner may select the tab corresponding to the workspace “Sample Corp” to review the websites and settings associated with this workspace. Initially, a workspace may not be associated with any websites until the web owner submits a request to create a new website for the workspace. For instance, as illustrated in FIG. 3A, for the workspace “Sample Corp” under the tab 304, there may be no websites listed as being associated with the workspace. However, the secure web hosting platform may provide a create new site button 308 within the workspace that, when selected, allows the website owner to submit a request to the secure web hosting platform to create a new website that may be associated with the selected workspace.

In addition to providing the website owner with different tabs 304 corresponding to their current workspaces, the secure web hosting platform may provide a create workspace button 306 that, when selected, may allow the website owner to submit a new request to the secure web hosting platform to generate a new workspace. This new workspace may initially be empty, as no websites may be initially associated with this new workspace. Through selection of the create workspace button 306, the website owner may define a name for the new workspace, as well as select any configuration options corresponding to the virtual machine instances that may be provisioned for hosting any websites associated with the workspace and for encoding these websites into data streams that may be used to generate graphical facsimiles of these websites. Once a workspace has been generated, the secure web hosting platform may allow the website owner to revise their configuration option selections, such as through a settings options as illustrated in FIG. 3A.

If the website owner selects the create new site button 308 within the selected workspace, the secure web hosting platform may update the secure web hosting platform main window 302 to present various options for creation of this new website. For example, as illustrated in FIG. 3B, the secure web hosting platform may update the secure web hosting platform main window 302 to provide an option 310 for generating a hosted website and an option 312 for mirroring an existing site through a virtual machine instance instantiated by the secure web hosting platform. If the website owner selects the option 312 to mirror an existing site onto a virtual machine instance, the secure web hosting platform may provide the website owner with one or more options corresponding to different protocols that may be used to encode one or more portions of the web DOM associated with the website. For example, the website owner may be provided, through the secure web hosting platform main window 302, with a set of protocols made available by the secure web hosting platform for encoding the website according to any of the aforementioned methods. For instance, through the secure web hosting platform main window 302, the secure web hosting platform may present the administrator with options to utilize a WebRTC protocol, a VNC protocol, any custom protocols or encoders defined by the secure web hosting platform and the like for encoding of the website. Additionally, the secure web hosting platform may provide the website owner with an option to define the network addresses corresponding to the web servers maintained by the website owner and from which the secure web hosting platform may retrieve the web DOM and corresponding web assets associated with the website.

Based on the information provided by the website owner, the secure web hosting platform may configure a virtual machine instance in the site rendering subnetwork to serve as a proxy of the website in order to encode the web DOM associated with the particular website into a graphical facsimile of the particular website for users. The secure web hosting platform may further update one or more DNS servers to map the URI associated with the particular website with an IP address corresponding to the virtual machine instance implemented in the site rendering subnetwork. For example, while the data (e.g., web DOM, web assets, etc.) associated with the website may reside within one or more web servers maintained by the website owner, the URI corresponding to the website may be mapped to an IP address associated with the virtual machine instance implemented by the secure web hosting platform in the site rendering subnetwork as opposed to an IP address associated with the one or more web servers. Further, the secure web hosting platform may configure the virtual machine instance implemented by the secure web hosting platform within the site rendering subnetwork to automatically access the one or more web servers in response to a request to access the website to obtain the web DOM and other assets associated with the website for encoding into the graphical facsimile of the website. Thus, if a user enters the URI corresponding to the website, the user may be automatically directed to the virtual machine instance implemented by the secure web hosting platform as opposed to the one or more web servers that maintain the web DOM and other assets associated with the particular website.

As illustrated in FIG. 3B, the website owner has selected the hosted website option 310, which may correspond to a website owner request to have the secure web hosting platform host a website on behalf of the website owner. In response to selecting this option 310, the secure web hosting platform may update the secure web hosting platform main window 302 to provide the website owner with different fields for providing various details regarding the new website that is to be hosted by the secure web hosting platform. For example, the secure web hosting platform may provide, through the secure web hosting platform main window 302, a title field 314. Through the title field 314, the website owner may provide a title for the website. This title may be used to identify the particular website within the selected workspace. The secure web hosting platform may further provide, through the secure web hosting platform main window 302, a site description field 316, through which the website owner may provide a description of the website (e.g., contents of the website, subject of the website, etc.).

Once the website owner has provided a title and description for the website that is to be hosted through the secure web hosting platform, the website owner may select a create site button 318 to finalize their request to provision a hosted website instance within the site hosting subnetwork and through which the website may be hosted. In response to selection of the create site button 318, the secure web hosting platform may update the secure web hosting platform main window 302 to present the website owner with an option to manage the newly created website and the corresponding hosted website instance. For example, as illustrated in FIG. 3C, the new website created by the website owner through the secure web hosting platform may be listed as being associated with the workspace “Sample Corp.” Within the workspace, the secure web hosting platform may specify the provided details 320 associated with the website. For example, as illustrated in FIG. 3C, the secure web hosting platform may indicate, as the provided details 320, that the website “Sample Home Page” is a website that is hosted by the secure web hosting platform (e.g., “Sample Home Page (Hosted)”). Further, within the provided details 320, the secure web hosting platform may provide the website description provided by the website owner through the site description field 316 described above (e.g., “This is the homepage for Sample Corp.”).

For each website listed as being associated with a particular workspace, the secure web hosting platform may provide the website owner with a manage button 322 that, when selected, may allow the website owner to manage various features associated with the corresponding website hosted by the secure web hosting platform. For example, if the website owner selects the manage button 322 (as illustrated in FIG. 3C), the secure web hosting platform may update the secure web hosting platform main window 302 to present the website owner with information corresponding to the hosted website and the hosted website instance instantiated by the secure web hosting platform within the site hosting subnetwork for hosting the website.

As illustrated in FIG. 3D, the secure web hosting platform may provide several details related to the website and the hosted website instance instantiated for hosting of the website. For example, through an identifier field 324, the secure web hosting platform may indicate the unique identifier corresponding to the website. As noted above, when a website owner submits a request to the secure web hosting platform to host a website on behalf of the website owner (such as through selection of the create site button 318 illustrated in FIG. 3B), the secure web hosting platform may automatically generate and assign a unique identifier corresponding to the website. Accordingly, the secure web hosting platform may provide this unique identifier to the website owner through the identifier field 324.

The secure web hosting platform may further provide a time created field 326, through which the secure web hosting platform may indicate when the website and the corresponding hosted website instance were created. In some instances, the time specified in the time created field 326 may correspond to the time at which the website owner selected the create site button 318 to request creation of the website and of the corresponding hosted website instance for hosting of the website.

The secure web hosting platform may further provide a title field 328 and a description field 330 for the selected website. The title field 328 may include the title of the website, as defined by the website owner through the title field 314 illustrated in FIG. 3B and presented in response to the website owner's selection of the create new site button 308 within the selected workspace. The description field 330 may include the description of the website provided by the website owner through the site description field 316 illustrated in FIG. 3B.

In addition to providing the unique identifier associated with the website and the corresponding hosted website instance, the secure web hosting platform, through a slug field 332, may provide the slug associated with the website and the corresponding hosted website instance. As noted above, the secure web hosting platform may generate, from the unique identifier, a slug that may be used to represent the unique identifier assigned to the website. In some instances, the slug may include a portion of the unique identifier. For example, as illustrated in FIG. 3D, the slug “1322a261e6” may correspond to the first nine characters of the unique identifier specified in the identifier field 324 (i.e., “1322a261-e6 . . . ”). In some instances, the slug may include an alternative unique identifier that may also have a probability of being not unique that is low enough to be considered unique within the context of the unique identifiers (e.g., UUIDs, GUIDs, etc.) generated for the website and the corresponding hosted website instance. Thus, the slug may represent a shortened version of the unique identifier. As noted above, the slug may be used to identify the hosted website instance to which a web DOM and any associated web assets may be uploaded.

The secure web hosting platform may further provide, through the secure web hosting platform main window 302, a type field 334. Through the type field 334, the secure web hosting platform may indicate whether the particular website is being hosted by the secure web hosting platform through a hosted website instance or is being mirrored from one or more web servers maintained by the website owner. As illustrated in FIG. 3D, the newly created website is a hosted website for which a hosted website instance has been instantiated.

The secure web hosting platform may further provide a latest deployment field 336 through which the secure web hosting platform may indicate the time at which the web DOM and corresponding web assets associated with the website were uploaded to the hosted website instance implemented by the secure web hosting platform. If the website is being mirrored from one or more web servers associated with the website owner, the latest deployment field 336 may be absent from the secure web hosting platform main window 302 as the web DOM and corresponding web assets may be obtained for encoding on an on-demand basis (e.g., in response to user requests to access the website).

As noted above, in addition to generating a unique identifier corresponding to a website hosted through a hosted website instance, the secure web hosting platform may automatically assign, by default a URI for the website and that may be used by a user to access the data stream for generating a graphical facsimile of the website. This default URI for the website may be presented through a domain window 340 within the secure web hosting platform main window 302. Through the domain window 340, the website owner may review any URIs generated for the website implemented through the hosted website instance and that is associated with the virtual machine instance through which a data stream encoding a graphical facsimile of the website may be obtained. When the default URI is generated for the website, the secure web hosting platform may update one or more DNS servers to associate this default URI with the IP address of the virtual machine instance provisioned to encode the website from the hosted website instance into a data stream that may be transmitted to requesting users.

As illustrated in FIG. 3D, the secure web hosting platform may provide an add new domain button 338 that may be selected to submit a request to the secure web hosting platform to associate a particular URI with the website. In response to the request, the secure web hosting platform may query the one or more DNS servers to determine whether the requested URI is available for the website. If the requested URI is assigned to another entity, the secure web hosting platform may update the secure web hosting platform main window 302 to indicate that the requested URI is not available. If the requested URI is available, the secure web hosting platform may update the one or more DNS servers to map the requested URI with the IP address corresponding to the virtual machine instance instantiated to encode the web DOM associated with the particular website into a graphical facsimile of the particular website for users. Further, the secure web hosting platform may update the domain window 340 to include the new URI associated with the website.

In some instances, and as illustrated in FIG. 3D, the secure web hosting platform may provide a delete button 342 for each URI specified in the domain window 340. If the website owner selects the delete button 342 for a particular URI, the secure web hosting platform may disassociate the particular URI from the website and the virtual machine instance provisioned to encode the website from the hosted website instance into a data stream. For instance, the secure web hosting platform may update the one or more DNS servers to remove the association between the particular URI and the IP address associated with the virtual machine instance implemented by the secure web hosting platform in the site rendering subnetwork for encoding of the website into a data stream. If the deleted URI was the sole URI associated with the website, the secure web hosting platform may update the secure web hosting platform main window 302 to indicate that the website cannot be rendered without an associated URI. This may serve as a prompt to the website owner to select the add new domain button 338 to request a new URI for the website. In some instances, if the deleted URI was the sole URI associated with the website, the secure web hosting platform may automatically assign a default URI for the website. As noted above, the secure web hosting platform may dynamically generate a URI that encodes the unique identifier associated with the website. Alternatively, the secure web hosting platform may generate a URI for the website at random by default. When the secure web hosting platform assigns this default URI to the website, the secure web hosting platform may update the one or more DNS servers to map the default URI with the IP address corresponding to the virtual machine instance instantiated to encode the web DOM associated with the particular website into a graphical facsimile of the particular website.

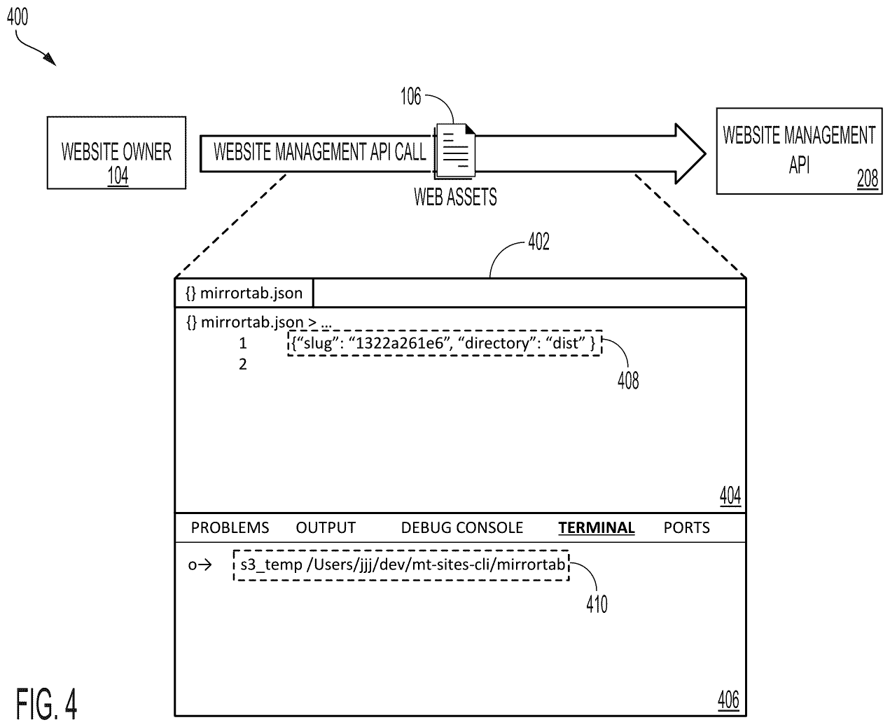

FIG. 4 shows an illustrative example of an environment 400 in which a website owner 104 submits an API call through a CLI to a website management API 208 implemented by the secure web hosting platform to provide a set of web assets 106 for a website to be hosted through the secure web hosting platform in accordance with at least one embodiment. As noted above, the secure web hosting platform exposes a website management API 208 through which a website owner 104 may deploy a web DOM and corresponding web assets 106 for a particular website to the secure web hosting platform for rendering of the website through a hosted website instance. In the environment 400, to upload the web DOM and corresponding web assets 106 for a particular website, the website owner 104 may execute a terminal 402 on their computing device. Through the terminal 402, the website owner 104 may execute a JSON document editor 404 that may be used to generate a JSON document that may be executed to retrieve and upload the web DOM and corresponding web assets to the hosted website instance through the website management API 208.

The format required for the JSON document may be defined by the secure web hosting platform, as the JSON document may need to be structured in a manner such that the website management API 208 may process the JSON document and allow for uploading of the web DOM and corresponding web assets 106. As illustrated in FIG. 4, through the JSON document editor 404, the website owner 104 may provide programmatic code 408 that defines the slug associated with the hosted website instance to which the web DOM and corresponding web assets 106 are to be uploaded. The slug value defined through the programmatic code 408 may be provided by the secure web hosting platform. For instance, as noted above, when the website owner 104 provisions a website and hosted website instance through an interface provided by the secure web hosting platform (such as the interface 300 described above in connection with FIGS. 3A-3D), the secure web hosting platform may generate and assign a unique identifier to the website and corresponding hosted website instance. Further, the secure web hosting platform may define a slug that may be associated with this unique identifier. As noted above, the slug may include a portion of the unique identifier. Alternatively, the slug may include an alternative unique identifier that may also have a probability of being not unique that is low enough to be considered unique within the context of the unique identifiers (e.g., UUIDs, GUIDs, etc.) generated for the website and the corresponding hosted website instance. The website owner 104, through the provided interface, may obtain the slug associated with the website and corresponding hosted website instance and insert the slug into the programmatic code 408.

In addition to providing the slug associated with the website and the corresponding hosted website instance, the website owner 104, through the programmatic code 408, may define the directory within the website owner's computing environment where the web DOM and corresponding web assets 106 for the website are maintained. The directory defined through the programmatic code 408 may correspond to the location within the website owner's computing device from where the JSON document is executed from. For example, if the JSON document is executed from the “s3_temp/Users/jjj/dev/mt-sites-cli/” directory, and the programmatic code 408 defines “dist” as being the directory where the web DOM and corresponding web assets 106 are maintained, the web DOM and corresponding web assets 106 may be defined as being within a “s3_temp/Users/jjj/dev/mt-sites-cli/dist” directory. Thus, the location from which the JSON document is executed may serve as the predicate for the directory defined through the programmatic code 408 of the JSON document.

Once the website owner 104 has defined a new JSON document through the JSON document editor 404, the website owner 104, through a terminal window 406, may enter a command 410 for generating and transmitting an API call to the website management API 208. The command 410 may be entered through a CLI provided by the secure web hosting platform. For instance, as illustrated in FIG. 4, through the CLI the website owner 104 may enter the command “s3_temp/Users/jjj/dev/mt-sites-cli/mirrortab” in the terminal window 406. In response to the command 410 entered through the CLI, the website management API 208 may execute the JSON document to identify the directory within which the web DOM and corresponding web assets 106 are maintained. Further, through execution of the JSON document, the website management API 208 may identify the hosted website instance to which the web DOM and corresponding web assets 106 are to be uploaded.

Execution of the command 410 through the CLI may result in the generation of an API call to the website management API 208 to upload the web DOM and corresponding web assets 106 to the indicated hosted website instance. Accordingly, when the JSON document is executed as a result of the API call to the website management API 208, the web DOM and corresponding web assets 106 may be automatically uploaded to the secure web hosting platform, which may store the web DOM and corresponding web assets 106 in association with the indicated hosted website instance. For instance, as the web DOM and web assets 106 are uploaded from the indicated directory to the secure web hosting platform, the website management API 208 may automatically transfer the web DOM and web assets 106 to the hosted website instance corresponding to the indicated slug. The hosted website instance may automatically process the uploaded web DOM and web assets 106 to render the website within the site hosting subnetwork. As noted above, users are prevented from accessing this hosted website instance within the site hosting subnetwork. Instead, users may access a data stream that encodes a graphical facsimile of the website through a separate virtual machine instance implemented within the website rendering subnetwork.

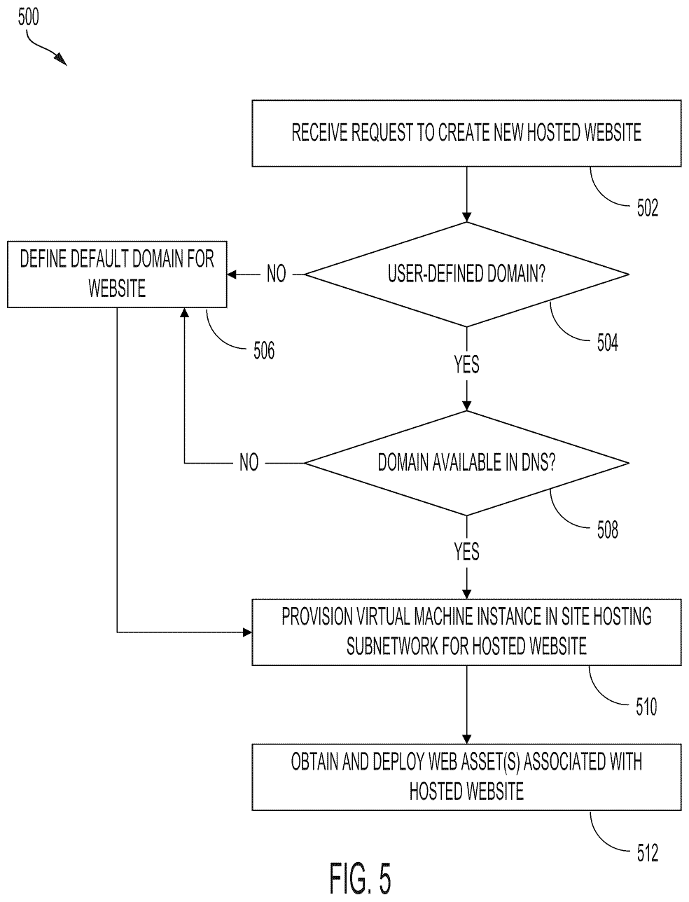

FIG. 5 shows an illustrative example of a process 500 for hosting a website through a virtual machine instance in accordance with at least one embodiment. The process 500 may be performed by the secure web hosting platform described herein. Further, certain operations of the process 500 may be performed through a website management API exposed by the secure web hosting platform and that may interact with different systems within a website owner's computing environment.

At step 502, the secure web hosting platform may receive a request to create a new hosted website. The request to create a new hosted website may specify one or more configuration options for a hosted website instance through which a virtual environment may be implemented for the website within a site hosting subnetwork. Further, the request may specify one or more configuration options for a virtual machine instance through which the website may be encoded into a data stream that may be transmitted to users requesting access to the website. In some instances, the request to create a new hosted website may further include one or more URIs that the website owner would like to associate with the website that is to be hosted through a hosted website instance. It should be noted that the request for specific URIs for a hosted website may be optional and, thus, the website owner may not be required to provide specific URIs for the hosted website.

At step 504, the secure web hosting platform may determine whether the website owner has requested a user-defined domain for the hosted website. As noted above, a website owner may submit a request to the secure web hosting platform to associate a particular URI with the website. For instance, the website owner may wish to assign a URI that encodes the name of a particular brand and that may be easy for users to remember when trying to access the website. Additionally, the website owner may wish to associate the website with different variations of a particular URI in order to reduce the likelihood of website spoofing, domain name squatting, and the like by other entities.

If the request to create the new hosted website does not include a user-defined domain (e.g., URI) for the website, the secure web hosting platform, at step 506, may define a default domain for the hosted website. As noted above, when a website owner submits a request to the secure web hosting platform to host a website within a hosted website instance in the site hosting subnetwork, the secure web hosting platform may automatically generate and assign a unique identifier (e.g., UUID, GUID, etc.) to the hosted website instance and the website. In addition to generating a unique identifier corresponding to the hosted website instance and the website, the secure web hosting platform may automatically assign a URI to the website. The default URI for the hosted website may embed the unique identifier assigned to the hosted website instance and the website. For example, the default URI may include, as the subdomain, the unique identifier or a slug associated with the unique identifier. The URI may include, as the second-level domain, the entity name of the secure web hosting platform. In some instances, the URI may be generated at random. For example, if the URI includes a subdomain and second-level domain, these domains may be defined at random by the secure web hosting platform.

If the request from the website owner includes one or more specific URIs that the website owner would like to have associated with the hosted website, the secure web hosting platform, at step 508, may determine whether these one or more specific URIs are available in the DNS. For instance, the secure web hosting platform may query the one or more DNS servers to determine whether the specified one or more URIs are available for the website. If the specified one or more URIs are assigned to another entity or is otherwise unavailable, the secure web hosting platform may transmit a notification to the website owner indicating that the specified one or more URIs are not available for the website. In some instances, if the requested one or more URIs are not available, the secure web hosting platform may, at step 506, automatically define a default URI for the website, as described above.

If a URI requested by the website owner is available, or the secure web hosting platform has defined a default URI for the hosted website, the secure web hosting platform may update the one or more DNS servers to map the URI to the IP address corresponding to the virtual machine instance in the site rendering subsystem and that is configured to encode the website into a data stream, as noted above. Additionally, at step 510, the secure web hosting platform may provision a hosted website instance in the site hosting subnetwork of the secure web hosting platform for the hosted website. For instance, based on the configuration requirements specified by the website owner in their request to the secure web hosting platform, the secure web hosting platform may instantiate a hosted website instance within the site hosting subnetwork of the secure web hosting platform that may be used to host the particular website. Further, the secure web hosting platform may instantiate a virtual machine instance within the site rendering subnetwork, which may be configured to encode the web DOM and corresponding web assets associated with the hosted website from the hosted website instance into a data stream that may be transmitted to users.

At step 512, the secure web hosting platform may obtain and deploy the web DOM and corresponding web assets associated with the hosted website. As noted above, to allow for configuration of the website through the hosted website instance, the secure web hosting platform may implement a website management API through which the website owner may upload the web DOM and corresponding web assets to the hosted website instance. The secure web hosting platform may provide, to the website owner, a CLI through which the website owner may submit an API call to the website management API to upload the web DOM and corresponding web assets associated with the website. Through the CLI, the website owner may specify at least a portion of the unique identifier assigned to the website by the secure web hosting platform and the directory within which the web DOM and corresponding web assets for the website are maintained. In response to the API call from the website owner, the website management API may process the data to identify the hosted website instance for which the web DOM and corresponding web assets are to be stored and used to implement the website. As the web DOM and web assets are uploaded from the indicated directory, the website management API may automatically transfer the web DOM and web assets to the hosted website instance for rendering of the website. The hosted website instance may automatically process the uploaded web DOM and web assets to render the website within the site hosting subnetwork.

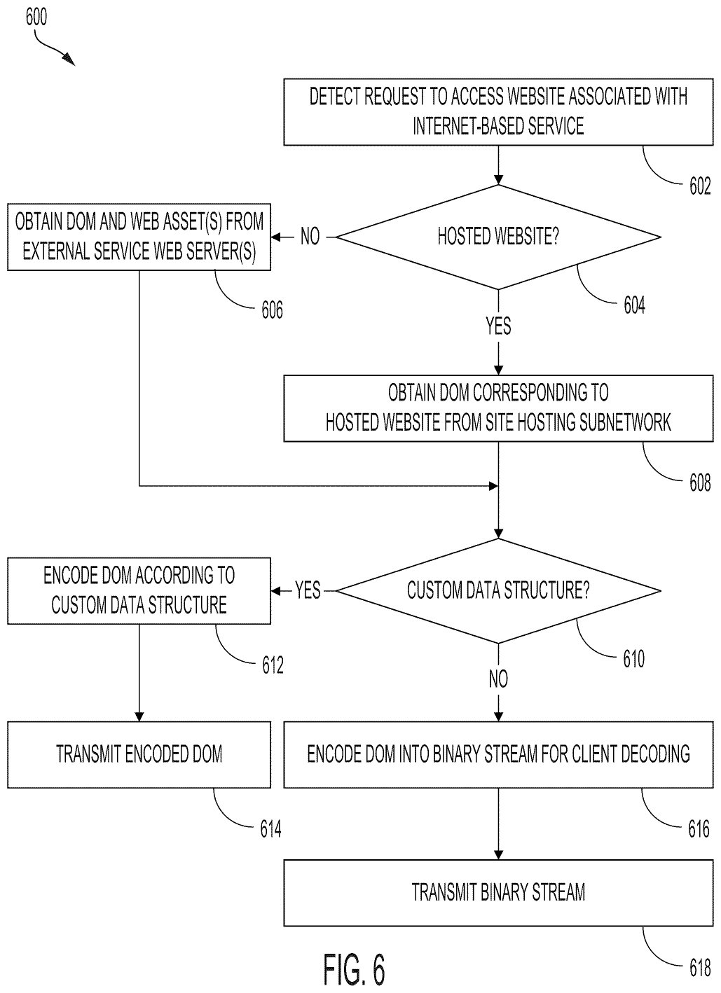

FIG. 6 shows an illustrative example of a process 600 for encoding a web DOM associated with a hosted website in order to prevent exposure of the web DOM while providing a representation of the hosted website to a user accessing the hosted website in accordance with at least one embodiment. The process 600 may be performed by a virtual machine instance operating within the site rendering subnetwork, implemented by a secure web hosting platform, and that is configured to automatically, and in real-time, encode the web DOM associated with a particular website into a data stream that may be used by a browser application to render a graphical facsimile of the website that does not expose the original web DOM associated with the website.

At step 602, the virtual machine instance may detect a request to access a website associated with an internet-based service (e.g., an entity that provides web content through one or more web servers or through a hosted website instance maintained by the secure web hosting platform, etc.). As noted above, when a website owner configures the virtual machine instance to serve as a proxy for the website, the secure web hosting platform updates one or more DNS servers to map the URI associated with the website with an IP address corresponding to the virtual machine instance. If a user enters, through a browser application implemented on their computing device, the URI corresponding to the website, the one or more DNS servers may return, to the user's browser application, the IP address corresponding to the virtual machine instance. The user's browser application may use this IP address to automatically submit a request to the virtual machine instance implemented by the secure web hosting platform to access the website.

At step 604, the virtual machine instance may determine whether the particular website is a hosted website that is maintained through a hosted website instance in the site hosting subnetwork of the secure web hosting platform. For instance, the virtual machine instance may query the web assets datastore (such as the web assets datastore 214 described above in connection with FIGS. 2A-2C) to determine whether the URI associated with the website corresponds to a particular hosted website instance implemented to host the website.

If the virtual machine instance determines that the website is not being hosted through a hosted website instance in the site hosting subnetwork, the virtual machine instance, at step 606, may obtain the web DOM and corresponding web assets from one or more external web servers associated with the website owner. For instance, the virtual machine instance may query the one or more web servers associated with the website to obtain the web DOM and any other assets and scripts that may be encoded to render a graphical facsimile of the website. The web DOM may provide a representation of the website that may be used, by the virtual machine instance, to programmatically and locally render the website on the virtual machine instance without exposing the web DOM to any other entities.

If the virtual machine instance determines that the website is being hosted through a hosted website instance in the site hosting subnetwork, the virtual machine instance, at step 608, may obtain the web DOM and corresponding web assets from the hosting website instance. For instance, the virtual machine instance may establish a secure communications session with the hosted website instance within the site hosting subnetwork to query the hosted website instance for the web DOM and corresponding assets and scripts that may be encoded to render a graphical facsimile of the website. The secure communications session may be established to prevent user access to the hosted website instance and the site hosting subnetwork.

It should be noted that, in some instances, the web DOM and corresponding assets and scripts associated with the website may be cached or otherwise stored by the virtual machine instance to prevent repetitious querying of the one or more web servers or the hosted website instance in response to requests to access the website. For instance, the virtual machine instance may cache or otherwise store the web DOM and corresponding assets and scripts for a period of time, after which the virtual machine instance may again query the one or more web servers or the hosted website instance to obtain any updates to the web DOM and/or the assets/scripts associated with the website. In some instances, the one or more web servers or the hosted website instance may automatically push any updates to the web DOM and to the assets/scripts automatically to the virtual machine instance for local rendering of the website.

At step 610, the virtual machine instance may determine whether a custom data structure for encoding the web DOM associated with the website has been implemented for the website. As noted above, the secure web hosting platform may generate or otherwise implement a custom encoder for encoding of one or more portions of the web DOM associated with the website for delivery of the graphical facsimile of the website in response to the request. In some instances, the custom encoder may be implemented to encode text and a binary image associated with the website into a data format that may be compressed and encrypted for delivery to a client. The client may be provided with cryptographic key(s) for decrypting the data stream from the virtual machine instance. may decrypt and decompress the data stream comprising the encoded text and binary image.

If the secure web hosting platform has defined or otherwise implemented a custom data structure for encoding the web DOM associated with the website into a graphical facsimile of the website, the virtual machine instance, at step 612, may encode the web DOM according to this custom data structure. For instance, as noted above, the virtual machine instance may use the custom encoder corresponding to the custom data structure to encode the web DOM and corresponding assets and scripts according to a custom lightweight content aware method. For instance, this method may include encoding the text and a binary image of the website into a particular data format. This encoded data may be compressed and encrypted for delivery to the browser application or other requesting entity.

At step 614, the virtual machine instance may transmit the encoded web DOM and corresponding assets/scripts in the corresponding data format to the browser application or other requesting entity. As noted above, this encoded data may be compressed and encrypted prior to delivery to the browser application or other requesting entity. The browser application or other requesting entity, in response to receiving this encoded data, may decode the text and binary image to render the graphical facsimile of the particular website according to the definition of the custom encoder. In some instances, the decoder provided to the browser application or other requesting entity for decoding the encoded text and binary image may be defined through custom JavaScript libraries and/or other libraries defined using appropriate programming languages, as described above.

If the virtual machine instance determines that a custom data structure has not been defined for the particular website, the virtual machine instance, at step 616, may encode the web DOM and corresponding assets and scripts into a binary data stream. For instance, if using a default encoding mechanism (e.g., one or more WebRTC protocols, a VNC protocol, etc.), the virtual machine instance may encode one or more portions of the web DOM associated with the particular website, as well as any corresponding assets/scripts, into individual pixels that may be pushed or transmitted in a binary stream to the browser application or other requesting entity.

At step 618, the virtual machine instance may transmit the binary data stream to the browser application or other requesting entity to allow the browser application or other requesting entity to decode the binary stream and render a graphical facsimile of the website. For instance, as the virtual machine instance encodes the web DOM and the various assets/scripts associated with the website according to the default encoding method (e.g., one or more WebRTC protocols, a VNC protocol, etc.), the virtual machine instance may push or transmit, in real-time, the binary data stream that includes the encoded graphical facsimile of the website. The browser application may automatically, and in real-time, decode the encoded graphical facsimile of the website and present the graphical facsimile of the website. As noted above, the graphical facsimile of the website may appear identical to the original website. However, in some instances, if the user accesses, through the browser application, a browser menu corresponding to the presented graphical facsimile of the website, the option to inspect the website may be disabled to prevent the user from inspecting the website. In some instances, in addition to pushing or transmitting the data stream that includes the encoded graphical facsimile of the website, the virtual machine instance may transmit executable instructions to the browser application to disable this option to inspect the website.

As noted above, the web DOM corresponding to the graphical facsimile of the website may not include any of the data included in the original web DOM associated with the website. Thus, if a user or other entity is able to inspect the web DOM associated with the graphical facsimile of the website, this web DOM may include no data corresponding to the actual website. Instead, the web DOM corresponding to the graphical facsimile of the website may indicate that the presented website is a graphical facsimile of the website and, thus, no data corresponding to the underlying website can be presented.

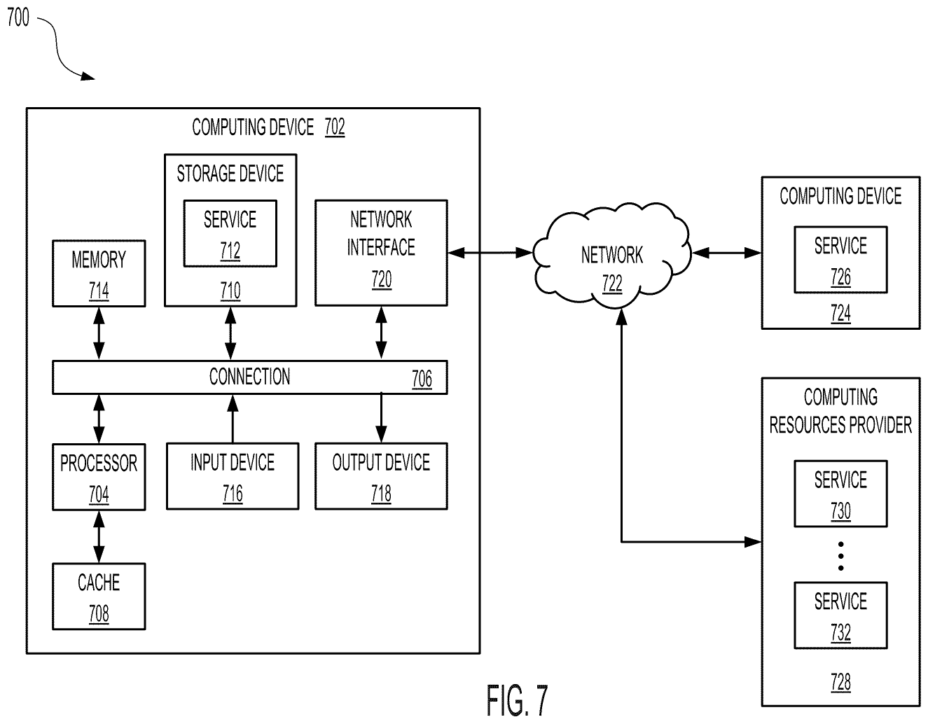

FIG. 7 illustrates a computing system architecture 700, including various components in electrical communication with each other, in accordance with some embodiments. The example computing system architecture 700 illustrated in FIG. 7 includes a computing device 702, which has various components in electrical communication with each other using a connection 706, such as a bus, in accordance with some implementations. The example computing system architecture 700 includes a processing unit 704 that is in electrical communication with various system components, using the connection 706, and including the system memory 714. In some embodiments, the system memory 714 includes read-only memory (ROM), random-access memory (RAM), and other such memory technologies including, but not limited to, those described herein. In some embodiments, the example computing system architecture 700 includes a cache 708 of high-speed memory connected directly with, in close proximity to, or integrated as part of the processor 704. The system architecture 700 can copy data from the memory 714 and/or the storage device 710 to the cache 708 for quick access by the processor 704. In this way, the cache 708 can provide a performance boost that decreases or eliminates processor delays in the processor 704 due to waiting for data. Using modules, methods and services such as those described herein, the processor 704 can be configured to perform various actions. In some embodiments, the cache 708 may include multiple types of cache including, for example, level one (L1) and level two (L2) cache. The memory 714 may be referred to herein as system memory or computer system memory. The memory 714 may include, at various times, elements of an operating system, one or more applications, data associated with the operating system or the one or more applications, or other such data associated with the computing device 702.

Other system memory 714 can be available for use as well. The memory 714 can include multiple different types of memory with different performance characteristics. The processor 704 can include any general purpose processor and one or more hardware or software services, such as service 712 stored in storage device 710, configured to control the processor 704 as well as a special-purpose processor where software instructions are incorporated into the actual processor design. The processor 704 can be a completely self-contained computing system, containing multiple cores or processors, connectors (e.g., buses), memory, memory controllers, caches, etc.

In some embodiments, such a self-contained computing system with multiple cores is symmetric. In some embodiments, such a self-contained computing system with multiple cores is asymmetric. In some embodiments, the processor 704 can be a microprocessor, a microcontroller, a digital signal processor (“DSP”), or a combination of these and/or other types of processors. In some embodiments, the processor 704 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 700, an input device 716 can represent any number of input mechanisms, such as a microphone for speech, a touch-sensitive screen for gesture or graphical input, keyboard, mouse, motion input, pen, and other such input devices. An output device 718 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 700. In some embodiments, the input device 716 and/or the output device 718 can be coupled to the computing device 702 using a remote connection device such as, for example, a communication interface such as the network interface 720 described herein. In such embodiments, the communication interface can govern and manage the input and output received from the attached input device 716 and/or output device 718. As may be contemplated, there is no restriction on operating on any particular hardware arrangement and accordingly the basic features here may easily be substituted for other hardware, software, or firmware arrangements as they are developed.

In some embodiments, the storage device 710 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 710 can include hardware and/or software services such as service 712 that can control or configure the processor 704 to perform one or more functions including, but not limited to, the methods, processes, functions, systems, and services described herein in various embodiments. In some embodiments, the hardware or software services can be implemented as modules. As illustrated in example computing system architecture 700, the storage device 710 can be connected to other parts of the computing device 702 using the system connection 706. In an embodiment, a hardware service or hardware module such as service 712, that performs a function can include a software component stored in a non-transitory computer-readable medium that, in connection with the necessary hardware components, such as the processor 704, connection 706, cache 708, storage device 710, memory 714, input device 716, output device 718, and so forth, can carry out the functions such as those described herein.

The disclosed processes for dynamically hosting of different websites through virtual hosting networks can be performed using a computing system such as the example computing system illustrated in FIG. 7, using one or more components of the example computing system architecture 700. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for implementing the virtual browser application environment described herein by, for example, executing code using a processor such as processor 704 wherein the code is stored in memory such as memory 714 as described herein. One or more of a user device, a provider server or system, a database system, or other such devices, services, or systems may include some or all of the components of the computing system such as the example computing system illustrated in FIG. 7, using one or more components of the example computing system architecture 700 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 728. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 704 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 714 can be coupled to the processor 704 by, for example, a connector such as connector 706, or a bus. As used herein, a connector or bus such as connector 706 is a communications system that transfers data between components within the computing device 702 and may, in some embodiments, be used to transfer data between computing devices. The connector 706 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 714 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 714 can also include magnetic or optical data storage media including read-only (e.g., CD ROM and DVD ROM) or otherwise (e.g., CD or DVD). The memory can be local, remote, or distributed.

As described above, the connector 706 (or bus) can also couple the processor 704 to the storage device 710, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 710. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 706 can also couple the processor 704 to a network interface device such as the network interface 720. The interface can include one or more of a modem or other such network interfaces including, but not limited to those described herein. It will be appreciated that the network interface 720 may be considered to be part of the computing device 702 or may be separate from the computing device 702. The network interface 720 can include one or more of an analog modem, Integrated Services Digital Network (ISDN) modem, cable modem, token ring interface, satellite transmission interface, or other interfaces for coupling a computer system to other computer systems. In some embodiments, the network interface 720 can include one or more input and/or output (I/O) devices. The I/O devices can include, by way of example but not limitation, input devices such as input device 716 and/or output devices such as output device 718. For example, the network interface 720 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™ SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 702 can be connected to one or more additional computing devices such as computing device 724 via a network 722 using a connection such as the network interface 720. In such embodiments, the computing device 724 may execute one or more services 726 to perform one or more functions under the control of, or on behalf of, programs and/or services operating on computing device 702. In some embodiments, a computing device such as computing device 724 may include one or more of the types of components as described in connection with computing device 702 including, but not limited to, a processor such as processor 704, a connection such as connection 706, a cache such as cache 708, a storage device such as storage device 710, memory such as memory 714, an input device such as input device 716, and an output device such as output device 718. In such embodiments, the computing device 724 can carry out the functions such as those described herein in connection with computing device 702. In some embodiments, the computing device 702 can be connected to a plurality of computing devices such as computing device 724, each of which may also be connected to a plurality of computing devices such as computing device 724. Such an embodiment may be referred to herein as a distributed computing environment.

The network 722 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 722 can be wired connections, wireless connections, or combinations thereof. Communications via the network 722 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 722, within the computing device 702, within the computing device 724, or within the computing resources provider 728 can include information, which also may be referred to herein as content. The information may include text, graphics, audio, video, haptics, and/or any other information that can be provided to a user of the computing device such as the computing device 702. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 702 and presented to a user of the computing device 702 using forms that are perceptible via sight, sound, smell, taste, touch, or other such mechanisms. In some embodiments, communications over the network 722 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 702 and/or the computing device 724 can be connected to a computing resources provider 728 via the network 722 using a network interface such as those described herein (e.g. network interface 720). In such embodiments, one or more systems (e.g., service 730 and service 732) hosted within the computing resources provider 728 (also referred to herein as within “a computing resources provider environment”) may execute one or more services to perform one or more functions under the control of, or on behalf of, programs and/or services operating on computing device 702 and/or computing device 724. Systems such as service 730 and service 732 may include one or more computing devices such as those described herein to execute computer code to perform the one or more functions under the control of, or on behalf of, programs and/or services operating on computing device 702 and/or computing device 724.

For example, the computing resources provider 728 may provide a service, operating on service 730 to store data for the computing device 702 when, for example, the amount of data that the computing device 702 exceeds the capacity of storage device 710. In another example, the computing resources provider 728 may provide a service to first instantiate a virtual machine (VM) on service 732, use that VM to access the data stored on service 732, perform one or more operations on that data, and provide a result of those one or more operations to the computing device 702. Such operations (e.g., data storage and VM instantiation) may be referred to herein as operating “in the cloud,” “within a cloud computing environment,” or “within a hosted virtual machine environment,” and the computing resources provider 728 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 728 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 730 and service 732 may implement versions of various services (e.g., the service 712 or the service 726) on behalf of, or under the control of, computing device 702 and/or computing device 724. Such implemented versions of various services may involve one or more virtualization techniques so that, for example, it may appear to a user of computing device 702 that the service 712 is executing on the computing device 702 when the service is executing on, for example, service 730. As may also be contemplated, the various services operating within the computing resources provider 728 environment may be distributed among various systems within the environment as well as partially distributed onto computing device 724 and/or computing device 702.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 702) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 5-6). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 702.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving a hosting request to host a website on a virtual site hosting subnetwork, wherein the hosting request includes a web Document Object Model (DOM) and one or more assets associated with the web DOM, and wherein the website is implemented using the web DOM;
provisioning a hosted website instance for the website, wherein the hosted website instance provides the web DOM and the one or more assets through the virtual site hosting subnetwork;
receiving a website access request for accessing the website, wherein the website access request is received through a website rendering instance implemented through a virtual site rendering subnetwork;
encoding the web DOM and the one or more assets to generate data usable to generate a graphical facsimile of the website, wherein data is generated through the website rendering instance, and wherein the website rendering instance obtains the web DOM and the one or more assets from the hosted website instance; and
transmitting data to fulfill the website access request, wherein the data is transmitted through the website rendering instance, and wherein when the data is received, the data is decoded to generate and present the graphical facsimile of the website.

2. The computer-implemented method of claim 1, wherein the hosting request is transmitted through a command line interface (CLI) call to an application programming interface (API) associated with the virtual site hosting subnetwork.

3. The computer-implemented method of claim 1, wherein the web DOM and the one or more assets are not accessible through the website rendering instance.

4. The computer-implemented method of claim 1, wherein the data is generated using a Web Real-Time Communication (WebRTC) protocol, wherein the data includes a set of pixels generated using the WebRTC protocol, and wherein the set of pixels is used to generate the graphical facsimile of the website.

5. The computer-implemented method of claim 1, further comprising:
identifying a Uniform Resource Identifier (URI) associated with the website, wherein the URI is identified based on the hosting request; and
updating one or more DNS servers to map the URI to the website rendering instance.

6. The computer-implemented method of claim 1, further comprising:
transmitting a set of executable instructions that, as a result of being executed, cause an option to inspect the graphical facsimile of the website to become disabled.

7. The computer-implemented method of claim 1, wherein the web DOM and the one or more assets are encoded according to a custom data structure, and wherein the custom data structure is indicated through the hosting request.

8. A system, comprising:
one or more processors; and
memory storing thereon instructions that, as a result of being executed by the one or more processors, cause the system to:
receive a hosting request to host a website on a virtual site hosting subnetwork, wherein the hosting request includes a web Document Object Model (DOM) and one or more assets associated with the web DOM, and wherein the website is implemented using the web DOM;
provision a hosted website instance for the website, wherein the hosted website instance provides the web DOM and the one or more assets through the virtual site hosting subnetwork;
receive a website access request for accessing the website, wherein the website access request is received through a website rendering instance implemented through a virtual site rendering subnetwork;
encode the web DOM and the one or more assets to generate data usable to generate a graphical facsimile of the website, wherein the data is generated through the website rendering instance, and wherein the website rendering instance obtains the web DOM and the one or more assets from the hosted website instance; and
transmit data to fulfill the website access request, wherein the data is transmitted through the website rendering instance, and wherein when the data is received, the data is decoded to generate and present the graphical facsimile of the website.

9. The system of claim 8, wherein the hosting request is transmitted through a command line interface (CLI) call to an application programming interface (API) associated with the virtual site hosting subnetwork.

10. The system of claim 8, wherein the web DOM and the one or more assets are not accessible through the website rendering instance.

11. The system of claim 8, wherein the data is generated using a Web Real-Time Communication (WebRTC) protocol, wherein the data includes a set of pixels generated using the WebRTC protocol, and wherein the set of pixels is used to generate the graphical facsimile of the website.

12. The system of claim 8, wherein the instructions further cause the system to:
identify a Uniform Resource Identifier (URI) associated with the website, wherein the URI is identified based on the hosting request; and
update one or more DNS servers to map the URI to the website rendering instance.

13. The system of claim 8, wherein the instructions further cause the system to:
transmit a set of executable instructions that, as a result of being executed, cause an option to inspect the graphical facsimile of the website to become disabled.

14. The system of claim 8, wherein the web DOM and the one or more assets are encoded according to a custom data structure, and wherein the custom data structure is indicated through the hosting request.

15. A non-transitory, computer-readable storage medium storing thereon executable instructions that, as a result of being executed by one or more processors of a computer system, cause the computer system to:
receive a hosting request to host a website on a virtual site hosting subnetwork, wherein the hosting request includes a web Document Object Model (DOM) and one or more assets associated with the web DOM, and wherein the website is implemented using the web DOM;
provision a hosted website instance for the website, wherein the hosted website instance provides the web DOM and the one or more assets through the virtual site hosting subnetwork;
receive a website access request for accessing the website, wherein the website access request is received through a website rendering instance implemented through a virtual site rendering subnetwork;
encode the web DOM and the one or more assets to generate data usable to generate a graphical facsimile of the website, wherein the data is generated through the website rendering instance, and wherein the website rendering instance obtains the web DOM and the one or more assets from the hosted website instance; and
transmit data to fulfill the website access request, wherein the data is transmitted through the website rendering instance, and wherein when the data is received, the data is decoded to generate and present the graphical facsimile of the website.

16. The non-transitory, computer-readable storage medium of claim 15, wherein the hosting request is transmitted through a command line interface (CLI) call to an application programming interface (API) associated with the virtual site hosting subnetwork.

17. The non-transitory, computer-readable storage medium of claim 15, wherein the web DOM and the one or more assets are not accessible through the website rendering instance.

18. The non-transitory, computer-readable storage medium of claim 15, wherein the data is generated using a Web Real-Time Communication (WebRTC) protocol, wherein the data includes a set of pixels generated using the WebRTC protocol, and wherein the set of pixels is used to generate the graphical facsimile of the website.

19. The non-transitory, computer-readable storage medium of claim 15, wherein the executable instructions further cause the computer system to:
identify a Uniform Resource Identifier (URI) associated with the website, wherein the URI is identified based on the hosting request; and
update one or more DNS servers to map the URI to the website rendering instance.

20. The non-transitory, computer-readable storage medium of claim 15, wherein the executable instructions further cause the computer system to:
transmit a set of instructions that, as a result of being executed, cause an option to inspect the graphical facsimile of the website to become disabled.

21. The non-transitory, computer-readable storage medium of claim 15, wherein the web DOM and the one or more assets are encoded according to a custom data structure, and wherein the custom data structure is indicated through the hosting request.
